(19) United States
(12) Patent Application Publication
(10) Pub. No.: US 2023/0280961 A1
(43) Pub. Date: Sep. 7, 2023

(54) DEVICE MANAGEMENT SYSTEM, INFORMATION PROCESSING SYSTEM, INFORMATION PROCESSING DEVICE, DEVICE MANAGEMENT METHOD, AND NON-TRANSITORY RECORDING MEDIUM

(71) Applicants: Ayano INOUE, Kanagawa (JP); Susumu FUJIOKA, Kanagawa (JP)

(72) Inventors: Ayano INOUE, Kanagawa (JP); Susumu FUJIOKA, Kanagawa (JP)

(21) Appl. No.: 18/112,519

(22) Filed: Feb. 22, 2023

(30) Foreign Application Priority Data
Feb. 24, 2022 (JP) 2022-026944

(51) Int. Cl. G06F 3/14; H04N 5/76; G06K 7/14

(52) U.S. Cl. CPC G06F 3/14; G06K 7/1413; G06K 7/1417; H04N 5/76

(57) ABSTRACT

A device management system includes a first device including first circuitry to output a device identifier of the first device, a second device including second circuitry to acquire the device identifier output by the first device and transmit the device identifier to a communication terminal that communicates with an information processing server, and the information processing server. The information processing server includes third circuitry to receive the device identifier from the communication terminal; and enable the first device to be used in a communication with the communication terminal to process information relating to the communication in response to receiving the device identifier.

### CROSS REFERENCE TO RELATED APPLICATIONS

This patent application is based on and claims priority pursuant to 35 U.S.C. §119(a) to Japanese Patent Application No. 2022-026944, filed on Feb. 24, 2022, in the Japan Patent Office, the entire disclosure of which is hereby incorporated by reference herein.

### BACKGROUND

### Technical Field

The present disclosure relates to a device management system, an information processing system, an information processing device, a device management method, and a non-transitory recording medium.

### Related Art

Known telecommunication systems transmit images and audio from one site to one or more other sites in real time to allow users at remote sites to hold a teleconference.

In such telecommunication, a device such as an electronic whiteboard is sometimes used.

There is known a technique for facilitating authentication of participants in a conference. For example, a system of the related art includes an image capturing device that captures an image of the surroundings of the image capturing device and generates moving image (video) of the surroundings. The image capturing device reads a participation certificate, analyzes the participation certificate converted into image data, and accepts participation in a conference.

### SUMMARY

In one aspect, a device management system includes a first device including first circuitry to output a device identifier of the first device, a second device including second circuitry to acquire the device identifier output by the first device and transmit the device identifier to a communication terminal that communicates with an information processing server, and the information processing server. The information processing server includes third circuitry to receive the device identifier from the communication terminal; and enable the first device to be used in a communication with the communication terminal to process information relating to the communication, in response to receiving the device identifier.

In another aspect, an information processing system includes circuitry configured to receive, from a communication terminal, a device identifier identifying a first device and being output by the first device and acquired by a second device that communicates with the communication terminal. In response to receiving the device identifier, the circuitry enables the first device to be used in a communication for processing information relating to the communication.

In another aspect, a device management method performed by an information processing system, the method includes receiving, a device identifier identifying a first device from a communication terminal, and enabling the first device to be used in a communication for processing information relating to the communication in response to receiving the device identifier. The device identifier is output by the first device and acquired by a second device that communicates with the communication terminal.

In another aspect, a non-transitory recording medium stores a plurality of program codes which, when executed by one or more processors, causes the processors to perform the method described above.

In another aspect, an information processing device includes circuitry configured to acquire a device identifier output from another information processing device to be used in a communication. In response to receiving the device identifier, the circuitry transmits the device identifier to an information processing system that enables the another information processing device to be used in the communication.

In another aspect, an information processing device includes circuitry configured to acquire a device identifier output from another information processing device to be used in a communication; and transmit the device identifier to a communication terminal. The communication terminal transmits the device identifier to an information processing system, and the information processing system enables the another information processing device to be used in the communication in response to receiving the device identifier.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overview of the creation of a record for storing a screen of an application (hereinafter, referred to as an app) executed during a teleconference together with a panoramic image of surroundings according to embodiments of the present disclosure;

FIG. 2 is a diagram illustrating an overview of an operation performed by an information processing system according to embodiments, for associating an electronic whiteboard with a meeting device;

FIG. 3 is a diagram illustrating a configuration of a record creation system according to embodiments of the present disclosure:

FIG. 4 is a diagram illustrating a hardware configuration of the information processing system and a communication terminal according to embodiments of the present disclosure:

FIG. 5 is a diagram illustrating a hardware configuration of the meeting device according to embodiments of the present disclosure;

FIGS. 6A and 6B are diagrams illustrating an image capture range of the meeting device according to embodiments of the present disclosure;

FIG. 7 is a diagram illustrating a panoramic image and clipping of talker images according to embodiments of the present disclosure:

FIG. 8 is a diagram illustrating an example of a hardware configuration of the electronic whiteboard:

FIG. 9 is a block diagram illustrating a functional configuration, as individual blocks, of the communication terminal, the meeting device, and the information processing system of the record creation system according to Embodiment 1,

FIG. 10 is a diagram illustrating example items of information on a recorded video, stored in an information storage area:

FIG. 11 is a diagram illustrating an example of conference information managed by a communication management unit according to one embodiment;

FIG. 12 is a diagram illustrating an example of association information associating a conference identifier (ID) with a device ID each other, stored in an association storage area;

FIG. 13 is a block diagram illustrating, as individual blocks, a functional configuration of the electronic whiteboard according to one embodiment;

FIG. 14 is a diagram illustrating an example of information such as the device ID stored in a device information storage area;

FIG. 15 is a diagram illustrating an example of object information stored in an object information storage area:

FIG. 16 is a diagram illustrating an example of an initial screen displayed by an information recording application operating on the communication terminal after login;

FIG. 17 is a diagram illustrating an example of a recording setting screen displayed by the information recording application;

FIG. 18 is a diagram illustrating an example of a recording-in-progress screen displayed by the information recording application during recording;

FIG. 19 is a diagram illustrating an example of a conference list screen displayed by the information recording application;

FIG. 20 is a sequence diagram illustrating an operation performed by the record creation system to associate a meeting device with an electronic whiteboard, according to Embodiment 1:

FIG. 21 is a flowchart illustrating an operation of the information processing system according to Embodiment 1:

FIG. 22 is a flowchart illustrating an operation of the information recording application executing on the communication terminal, according to Embodiment 1;

FIG. 23 is a diagram illustrating an example of a message displayed by the information recording application executing the communication terminal;

FIG. 24 is a schematic diagram illustrating an example of a method for displaying a two-dimensional code performed by the electronic whiteboard;

FIG. 25 is a schematic diagram illustrating another example of a method for displaying a two-dimensional code performed by the electronic whiteboard according to one embodiment:

FIG. 26 is a schematic diagram illustrating another example of a method for displaying a two-dimensional code performed by the electronic whiteboard;

FIG. 27 is a schematic diagram illustrating another example of a method for displaying a two-dimensional code performed by the electronic whiteboard;

FIG. 28 is a schematic diagram illustrating another example of a method for displaying a two-dimensional code performed by the electronic whiteboard;

FIG. 29 is a schematic diagram illustrating another example of a method for displaying a two-dimensional code performed by the electronic whiteboard;

FIG. 30 is a schematic diagram illustrating a method for displaying a two-dimensional code by the electronic whiteboard in a case where the meeting device include a hemispherical camera, according to Embodiment 1;

FIG. 31 is a schematic diagram illustrating an example of a method for displaying a barcode performed by the electronic whiteboard, according to Embodiment 2;

FIG. 32 is a sequence chart illustrating an example of recording a panoramic image, a talker image, and an application screen by the information recording application, according to Embodiment 1;

FIG. 33 is a block diagram illustrating a functional configuration, as individual blocks, of the communication terminal, the meeting device, and the information processing system of the record creation system according to Embodiment 2;

FIG. 34 is a block diagram illustrating, as individual blocks, a functional configuration of the electronic whiteboard according to Embodiment 2;

FIGS. 35A to 35D are diagrams illustrating examples of a frequency of sound and a bit pattern used for transmission of a device identifier (ID);

FIG. 36 is a diagram illustrating an example of a frequency pattern representing one character of the device ID;

FIG. 37 is an example of a sequence diagram illustrating processing performed by the record creation system according to Embodiment 2;

FIGS. 38A to 38D illustrate examples of correspondence between frequencies and bit data in a case of ultrasonic waves;

FIG. 39 is an example of a sequence diagram illustrating processing when the record creation system ends recording of a conference, according to Embodiment 3;

FIG. 40 is a diagram illustrating an example of a conference end notification screen displayed by the electronic whiteboard;

FIG. 41 is a block diagram illustrating a functional configuration, as individual blocks, of the communication terminal, the meeting device, and the information processing system of the record creation system according to Embodiment 4;

FIG. 42 illustrates an example of an image representing a shape of the electronic whiteboard detected from a panoramic image;

FIG. 43 is an example of a sequence diagram illustrating processing when the record creation system ends recording of a conference, according to Embodiment 4;

FIG. 44 is a block diagram illustrating a functional configuration, as individual blocks, of the communication terminal, the meeting device, and the information processing system of the record creation system according to Embodiment 5; and

FIG. 45 is an example of a sequence diagram illustrating processing when the record creation system ends recording of a conference, according to Embodiment 5.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, descriptions are given of an information processing system and a method for managing devices performed by the information processing system as an exemplary embodiment of the present disclosure.

### Embodiment 1

### Example of Method of Creating Minutes of Teleconference

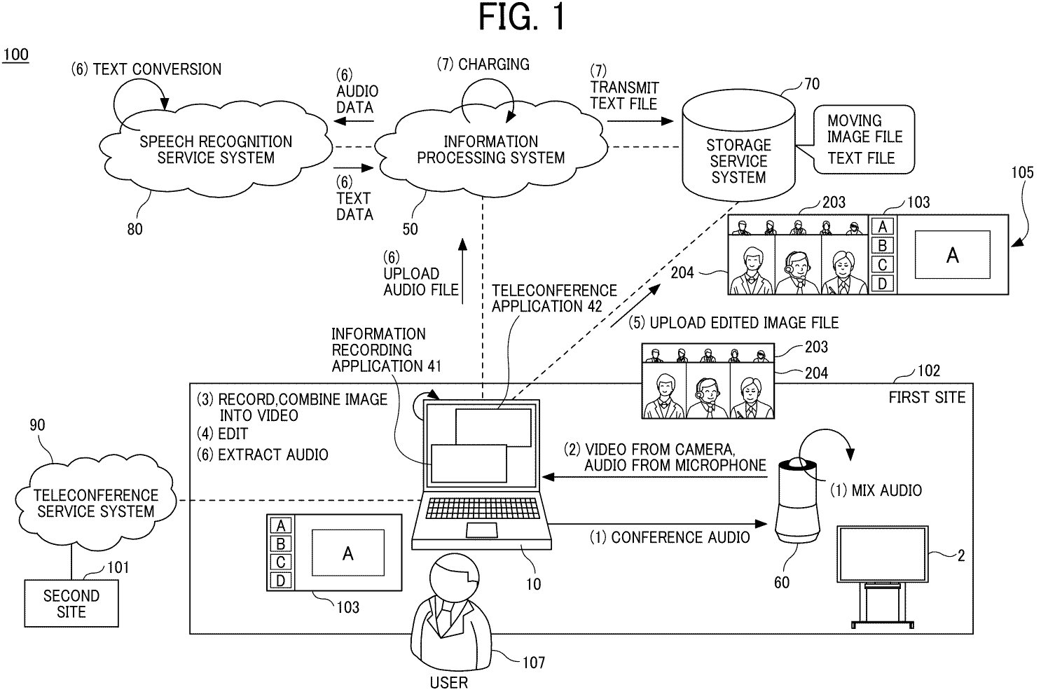

An overview of a method of creating minutes using a panoramic image and a screen of an application will be described with reference to FIG. 1. FIG. 1 is a diagram illustrating an overview of creation of record for storing a screen of an application executed during a teleconference, together with a panoramic image of surroundings. As illustrated in FIG. 1, a user 107 at a first site 102 uses a teleconference service system 90 to have a teleconference with a user at a second site 101.

A record creation system 100 according to the present embodiment creates a record (minutes) using a horizontal panoramic image (hereinafter “panoramic image”) and a screen provided by an application that executes on a communication terminal 10. The panoramic image is captured by a meeting device 60 that includes an image-capturing device, a microphone, and a speaker. The record creation system 100 combines audio data received by a teleconference application 42 and audio data obtained by the meeting device 60 together and includes the resultant audio data in the record. The overview will be described below.

On the communication terminal 10, an information recording application 41 described below and the teleconference application 42 are operating. Another application such as a document display application may also be operating. The information recording application 41 transmits audio data output by the communication terminal 10 (including audio data received by the teleconference application 42 from the second site 101) to the meeting device 60. The meeting device 60 mixes (combines) audio data obtained by the meeting device 60 and the audio data received by the teleconference application 42 together.

(2) The meeting device 60 includes the microphone. Based on a direction from which the microphone receives sound, the meeting device 60 performs clipping of a portion including a person speaking (i.e., a talker) from the panoramic image to create a talker image. The meeting device 60 transmits both the panoramic image and the talker image to the communication terminal 10.

The information recording application 41 operating on the communication terminal 10 displays a panoramic image 203 and talker images 204. The information recording application 41 combines the panoramic image 203 and the talker images 204 with a screen of a desired application (for example, a screen 103 of the teleconference application 42) selected by the user 107. For example, the information recording application 41 combines the panoramic image 203 and the talker images 204 with the screen 103 of the teleconference application 42 to create a combined image 105 such that the panoramic image 203 and the talker image 204 are arranged on the left side and the screen 103 of the teleconference application 42 is arranged on the right side. Since the processing (3) is repeatedly performed, the resultant combined images 105 become a moving image (hereinafter, referred to as a combined video). The information recording application 41 attaches the combined audio data to the combined video to create a video with sound.

In the present embodiment, an example of combining the panoramic image 203, the talker images 204, and the screen 103 of the teleconference application 42 together is described. Alternatively, the panoramic image 203. the talker images 204, and the screen 103 of the teleconference application 42 may be stored separately and arranged on a screen at the time of playback by the information recording application 41.

The information recording application 41 receives an editing operation (performed by the user 107 to cut off a portion not to be used), and completes the combined video. The combined video is a part of the record.

The information recording application 41 transmits the created combined video (with sound) to a storage service system 70 for storage.

The information recording application 41 extracts the audio data from the combined video (or may keep the original audio data to be attached) and transmits the extracted audio data to an information processing system 50. The information processing system 50 receives the audio data and transmits the audio data to a speech recognition service system 80 that converts the audio data into text data. The speech recognition service system 80 converts the audio data into text data. The text data includes data indicating a time, from the start of recording, when a speaker made an utterance.

In the case of real-time conversion into text data, the meeting device 60 transmits the audio data directly to the information processing system 50. The information processing system 50 transmits the text data obtained by speech recognition to the information recording application 41 in real time.

(7) The information processing system 50 additionally stores the text data in the storage service system 70 storing the combined video. The text data is a part of the record.

The information processing system 50 performs a charging process for a user according to a service that is used. For example, the charge is calculated based on an amount of the text data, a file size of the combined video, a processing time, or the like.

As described above, the combined video displays the panoramic image 203 of the surroundings including the user 107 and the talker images 204 as well as the screen of the application such as the teleconference application 42 displayed in the teleconference. When a participant or someone who has not attended the teleconference views the combined video as the minutes of the teleconference, the teleconference is reproduced with the realism.

### Overview of Process

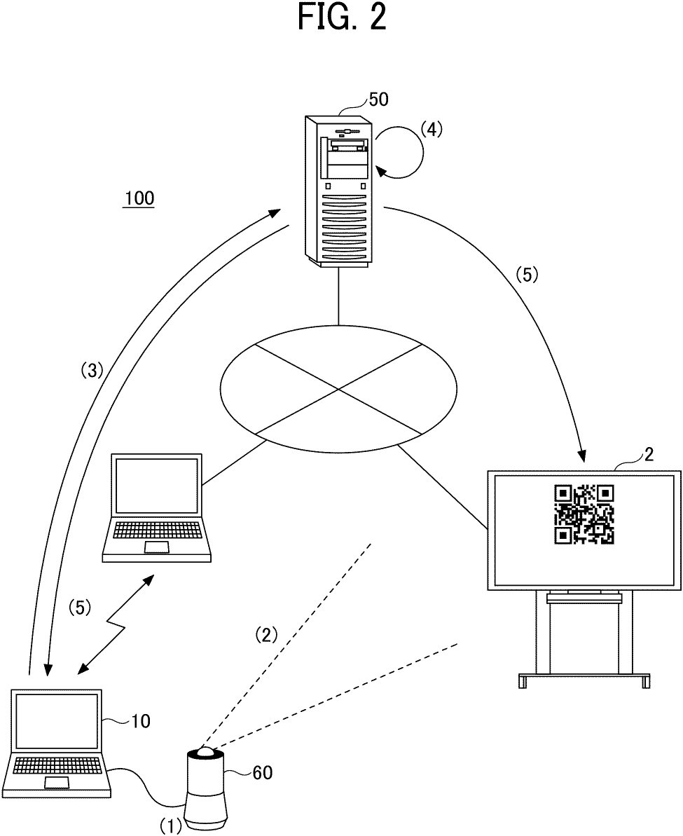

Next, association processing between the electronic whiteboard 2 (an example of first device and an example of another information processing device) and the meeting device 60 (an example of second device and an example of information processing device) will be described with reference to FIG. 2. The information processing system 50 serves as an information processing server. The information processing system 50 associates electronic whiteboard 2 with the conference to enable the electronic whiteboard 2 to be used in a teleconference for processing information related to the teleconference (e.g., storing objects handwritten on the electronic whiteboard 2 in association with the teleconference). Such associating is performed by a user in a conventional system.

FIG. 2 is a diagram illustrating an overview of an operation performed by the information processing system 50 for associating the electronic whiteboard 2 with the meeting device 60.
(1) A participant brings the meeting device 60 to a conference room in which the electronic whiteboard 2 (an example of the first device and an example of another device) is installed and places the meeting device 60 on a desk. The meeting device 60 is placed near the electronic whiteboard 2.
(2) The meeting device 60 captures an image of a two-dimensional code in which a device identifier (ID) of the electronic whiteboard 2 is embedded, and transmits image data thereof to the communication terminal 10.
(3) The communication terminal 10 detects the device ID from the image data and transmits the device ID to the information processing system 50.
(4) In response to receiving the device ID, the information processing system 50 issues a conference identifier (ID) and associates the device ID of the electronic whiteboard 2 with the conference ID.
The timing at which the information processing system 50 issues the conference ID is not limited thereto. For example, the conference ID may be issued in advance by an operation of the user, or may be automatically issued at the conference start time in cooperation with a scheduler.
(5) The information processing system 50 transmits a registration completion notification including the conference ID to the electronic whiteboard 2 and the communication terminal 10. As the electronic whiteboard 2 and the communication terminal 10 specify the conference ID and communicate with the information processing system 50, data handled by the electronic whiteboard 2 and the communication terminal 10 can be associated with the same conference. The information processing system 50 stores the image data (the panoramic image and the talker image) and the audio data acquired by the meeting device 60, the hand-drafted data input to the electronic whiteboard 2, and the like in association with the conference ID.

As described above, in the record creation system 100 according to the present embodiment, the meeting device 60 acquires the device ID of the device used in the conference room, and the communication terminal 10 transmits the device ID to the information processing system 50. Then, the information processing system 50 associates the device with the information processing system 50 as the device used in the conference. Since the meeting device 60 is connected to the communication terminal 10 that communicates with the information processing system 50, the meeting device 60 is also associated with the conference.

This configuration obviates the trouble of the user of capturing the two-dimensional code displayed by the device with the camera or registering the device and the meeting device 60 in the information processing system 50 for a conference. With this configuration, a plurality of devices (the meeting device 60 and the electronic whiteboard 2) can be associated with the conference (made usable) with minimum user intervention. Examples of enabling a device usable include, but not limited to: making the device usable in a conference: enabling the electronic whiteboard 2 to transmit hand-drafted stroke data, an image, or the like to the information processing system 50; enabling creation of minutes using information input to the electronic whiteboard 2; associating the electronic whiteboard 2 with the conference; enabling the electronic whiteboard 2 and the information processing system 50 to transmit and receive data to and from each other: causing the electronic whiteboard 2 to participate in a cloud electronic whiteboard service (a service for multiple communication terminals to write or draw a stroke or the like on the same screen in a teleconference). In addition, when an electronic whiteboard is enabled to be usable in a conference, the electronic whiteboard can be prevented from participating in another conference held at the same time. In addition, when an electronic whiteboard is made usable in a conference information displayed thereon and information (stroke information) drawn thereon can be included in minutes of the conference created by the information processing system or the like.

### Terminology

The term “application (app)” refers to software developed or used for a specific function or purpose, not software for operating a computer itself. That is, “application” is not an operating system (OS). Types of such applications include a native application and a web application.

The expression “application being executed” refers to an application in a state from the activation of an application to the end of the application. An application is not necessarily active (an application in the foreground) and may operate in the background.

An “image of the surroundings acquired by the meeting device 60” refers to an image captured in a wider angle of view than a normal angle of view in the horizontal direction. In the present embodiment, the image of the surroundings is referred to as a “panoramic image.” A panoramic image is an image having an angle of view of 180 degrees to 360 degrees in substantially the horizontal direction. The panoramic image is not necessarily captured by a single meeting device, and may be captured by a combination of a plurality of image-capturing devices having an ordinary angle of view.

The term “record” refers to information recorded (recorded information) by the information recording application 41. When the information recording application 41 records the screen of the teleconference application 42, the record may serve as minutes of a teleconference. The “record” includes, for example, a combined video (with sound) and text data obtained by performing speech recognition on the sound.

The term “tenant” refers to a group of users (such as a company, a local government, or an organization that is a part of such a company or local government) that has a contract to receive a service from a service provider. In the present embodiment, assuming that the tenant has a contract with the service provider, creation of the record and conversion into text data are performed.

The term “telecommunication” refers to audio-and-video-based communication with a counterpart at a physically remote site, using software and communication terminals.

A remote conference (teleconference) and a seminar are examples of telecommunication. A conference may also be referred to as an assembly, a meeting, an arrangement, a gathering, a meet, or a meet-up. A seminar may also be referred to as a workshop, a study meeting, a study session, or a training session.

The term “site” refers to a place where an activity is performed. A conference room is an example of the site. The conference room is a room installed for use in a conference.

The term “sound” and “audio” refers to an utterance made by a person, a surrounding sound, or the like. The term “audio data” refers to data to which the audio is converted. However, in the present embodiment, the audio and the audio data will be described without being strictly distinguished from each other.

The “first device” may be any device that display information. In the present embodiment, the first device is described with the term “electronic whiteboard.” The electronic whiteboard may also be referred to as an electronic information board or the like. A projector is known as the equivalent to an electronic whiteboard. Alternatively, the first device may be a digital signage, a television, a display, a multifunction peripheral, a video conference terminal, or the like in other embodiments.

The term “information related to communication” refers to information recorded in communication such as a conference, and is, for example, information displayed by an electronic whiteboard, an image captured by an image-capturing device, or voice of a speaker. Examples of devices that process information related to communication include the electronic whiteboard 2 and the meeting device 60. The meeting device 60 may include an image-capturing device.

To the first device and the communication terminal, the same identification information (information for associating a plurality of devices in communication) is transmitted. The same identification information is “conference ID” in the present embodiment, but may be any information.

### Example of System Configuration

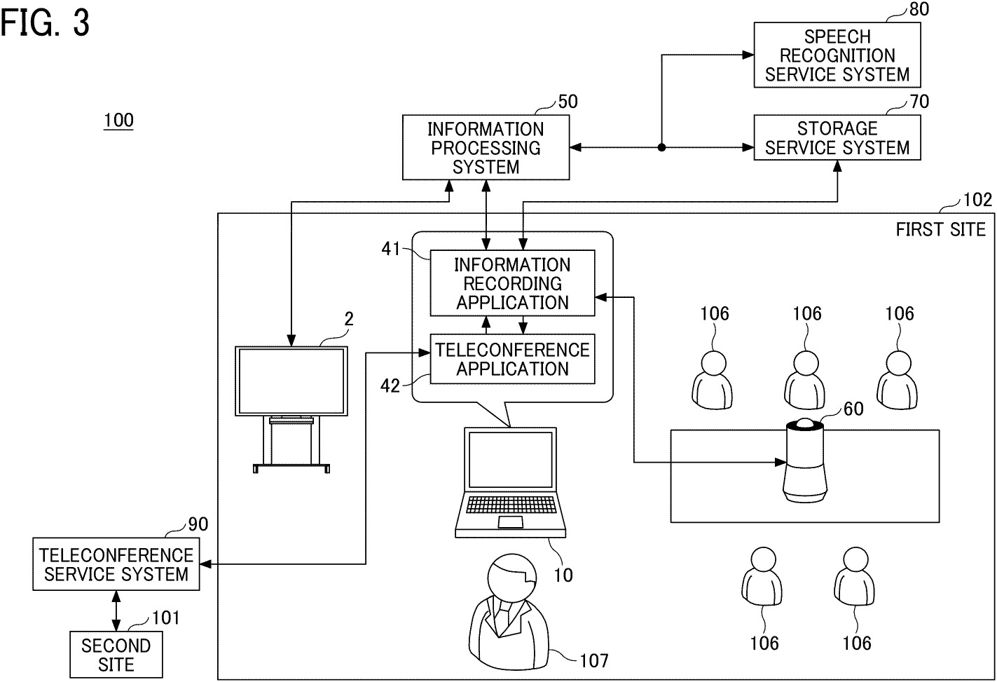

A system configuration of the record creation system 100 will be described with reference to FIG. 3. FIG. 3 illustrates an example of the configuration of the record creation system 100. FIG. 3 illustrates one site (the first site 102 on which the meeting device 60 is located) among a plurality of sites between which a teleconference is held. The communication terminal 10 at the first site 102 communicates with the information processing system 50, the storage service system 70, and the teleconference service system 90 via a network. The meeting device 60 and the electronic whiteboard 2 are disposed at the first site 102. The communication terminal 10 is connected to the meeting device 60 via, for example, a Universal Serial Bus (USB) cable to communicate therewith. The meeting device 60, the electronic whiteboard 2, and the information processing system 50 operate as a device management system.

At least the information recording application 41 and the teleconference application 42 operate on the communication terminal 10. The teleconference application 42 can communicate with the communication terminal 10 at the second site 101 via the teleconference service system 90 that resides on the network to allow users at the remote sites to participate in a teleconference. The information recording application 41 uses functions of the information processing system 50 and the meeting device 60 to create the record of the teleconference hosted by the teleconference application 42.

In the present embodiment, a description is given of an example in which the record of a teleconference is created. However, in another example, the conference is not necessarily held among remote sites. That is, aspects of the present disclosure are applicable to a conference held among the participants present at one site. In this case, the image captured by the meeting device 60 and the audio received by the meeting device 60 are independently stored without being combined. The rest of the processing performed by the information recording application 41 is similar to that of the present embodiment.

The communication terminal 10 includes a built-in (or external) camera having an ordinary angle of view. The camera of the communication terminal 10 captures an image of a front space including the user 107 who operates the communication terminal 10. Images captured by the camera having an ordinary angle of view are not panoramic images. In the present embodiment, the built-in camera having the ordinary angle of view primarily captures planar images that are not curved like spherical images. Thus, the user can participate in a teleconference using the teleconference application 42 as usual without paying attention to the information recording application 41. The information recording application 41 and the meeting device 60 do not affect the teleconference application 42 except for an increase in the processing load of the communication terminal 10. The teleconference application 42 can transmit a panoramic image or a talker image captured by the meeting device 60 to the teleconference service system 90.

The information recording application 41 communicates with the meeting device 60 to create a record of a conference. The information recording application 41 also synthesizes audio received by the meeting device 60 and audio received by the teleconference application 42 from another site. The meeting device 60 is a device for a meeting, including an image-capturing device that captures a panoramic image, a microphone, and a speaker. The camera of the communication terminal 10 can capture an image of only a limited range of the front space. In contrast, the meeting device 60 can capture an image of the entire surroundings (not necessarily the entire surroundings) around the meeting device 60. The meeting device 60 can always keep a plurality of participants 106 illustrated in FIG. 3 within the angle of view.

In addition, the meeting device 60 cuts out a talker image from a panoramic image. The meeting device 60 is placed on a table in FIG. 3, but may be placed anywhere in the first site 102. Since the meeting device 60 can capture a spherical image, the meeting device 60 may be disposed on a ceiling, for example.

The information recording application 41 displays a list of applications executing on the communication terminal 10, combines images for the above-described record (creates the combined video), plays the combined video, receives editing, and the like. Further, the information recording application 41 displays a list of teleconferences already held or are to be held in the future. The list of teleconferences is used in information on the record to allow the user to link a teleconference with the record.

The teleconference application 42 establishes communication connection with the second site 101, transmits and receives images and sound to and from the second site 101, displays images, and outputs audio.

The information recording application 41 and the teleconference application 42 each may be a web application or a native application. A web application is an application in which a program on a web server cooperates with a program on a web browser to perform processing, and is not to be installed on the communication terminal 10. A native application is an application that is installed and used on the communication terminal 10. In the present embodiment, both the information recording application 41 and the teleconference application 42 are described as native applications.

The communication terminal 10 may be a general-purpose information processing apparatus having a communication function, such as a personal computer (PC), a smartphone, or a tablet terminal, for example. Alternatively, the communication terminal 10 is, for example, an electronic whiteboard, a game console, a personal digital assistant (PDA), a wearable PC, a car navigation system, an industrial machine, a medical device, or a networked home appliance. The communication terminal 10 may be any apparatus on which the information recording application 41 and the teleconference application 42 operate.

The electronic whiteboard 2 displays, on a display, data handwritten on a touch panel with an input device such as a pen or a finger. The electronic whiteboard 2 can communicate with the communication terminal 10 or the like in a wired or wireless manner, and capture a screen displayed by the communication terminal 10 and display the screen on the display. The electronic whiteboard 2 can convert hand-drafted data into text data, and share information displayed on the display with the electronic whiteboard 2 at another site. The electronic whiteboard 2 may be a whiteboard, not including a touch panel, onto which a projector projects an image. The electronic whiteboard 2 may be a tablet terminal, a laptop computer or PC, a PDA, a game console, or the like including a touch panel.

The electronic whiteboard 2 can communicate with the information processing system 50. For example, after being powered on, the electronic whiteboard 2 performs polling on the information processing system 50 to receive information from the information processing system 50.

The information processing system 50 is implemented by one or more information processing apparatuses deployed over a network. The information processing system 50 includes one or more server applications that perform processing in cooperation with the information recording application 41, and an infrastructure service. The server applications manage, for example, a list of teleconferences, records of teleconferences, and various settings and storage paths.

The infrastructure service performs user authentication, makes a contract, performs charging processing, and the like.

All or some of the functions of the information processing system 50 may reside in a cloud environment or in an on-premises environment. The information processing system 50 may be implemented by a plurality of server apparatuses or a single information processing apparatus. For example, the server applications and the infrastructure service may be provided by separate information processing apparatuses. Further, each function of the server applications may be provided by an individual information processing apparatus. The information processing system 50 may be integral with the storage service system 70 and the speech recognition service system 80 described below.

The storage service system 70 is a storage means on a network, and provides a storage service for accepting the storage of files and the like. Examples of the storage service system 70 include MICROSOFT ONEDRIVE, GOOGLE WORKSPACE, and DROPBOX. The storage service system 70 may be on-premises network-attached storage (NAS) or the like.

The speech recognition service system 80 provides a service of speech recognition on audio data and converting the audio data into text data. The speech recognition service system 80 may be a general-purpose commercial service or a part of the functions of the information processing system 50.

### Example of Hardware Configuration

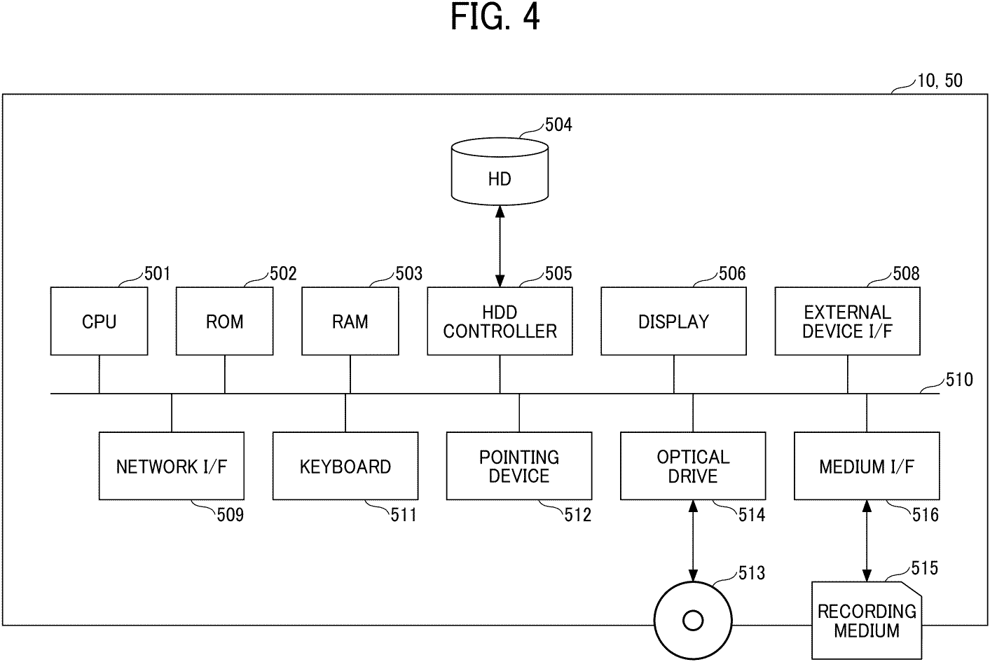

A hardware configuration of the information processing system 50 and the communication terminal 10 according to the present embodiment will be described with reference to FIG. 4.

### Information Processing System and Communication Terminal

FIG. 4 is a diagram illustrating an example of a hardware configuration of the information processing system 50 and the communication terminal 10 according to the present embodiment. As illustrated in FIG. 4, the information processing system 50 and the communication terminal 10 each are implemented by a computer and each include a central processing unit (CPU) 501, a read-only memory (ROM) 502. a random access memory (RAM) 503, a hard disk (HD) 504, a hard disk drive (HDD) controller 505, a display 506, an external device interface (I/F) 508, a network I/F 509, a bus line 510, a keyboard 511. a pointing device 512, an optical drive 514, and a medium I/F 516.

The CPU 501 controls the entire operations of the information processing system 50 and the communication terminal 10. The ROM 502 stores programs such as an initial program loader (IPL) to boot the CPU 501. The RAM 503 is used as a work area for the CPU 501. The HD 504 stores various kinds of data such as a program. The HDD controller 505 controls reading or writing of various kinds of data from or to the HD 504 under control of the CPU 501. The display 506 displays various kinds of information such as a cursor, a menu, a window, characters, or an image. The external device I/F 508 is an interface for connecting various external devices. Examples of the external devices in this case include, but are not limited to, a USB memory and a printer. The network I/F 509 is an interface for performing data communication via a network. The bus line 510 is, for example, an address bus or a data bus for electrically connecting the components such as the CPU 501 illustrated in FIG. 4 to one another.

The keyboard 511 is a kind of an input device including a plurality of keys used for inputting characters, numerical values, various instructions, or the like. The pointing device 512 is a kind of an input device used to select or execute various instructions, select a target for processing, or move a cursor. The optical drive 514 controls the reading or writing of various kinds of data from or to an optical recording medium 513 that is an example of a removable recording medium. The optical recording medium 513 may be a compact disc (CD), a digital versatile disc (DVD), a BLU-RAY disc, or the like. The medium I/F 516 controls reading or writing (storing) of data from or to a recording medium 515 such as a flash memory.

### Meeting Device

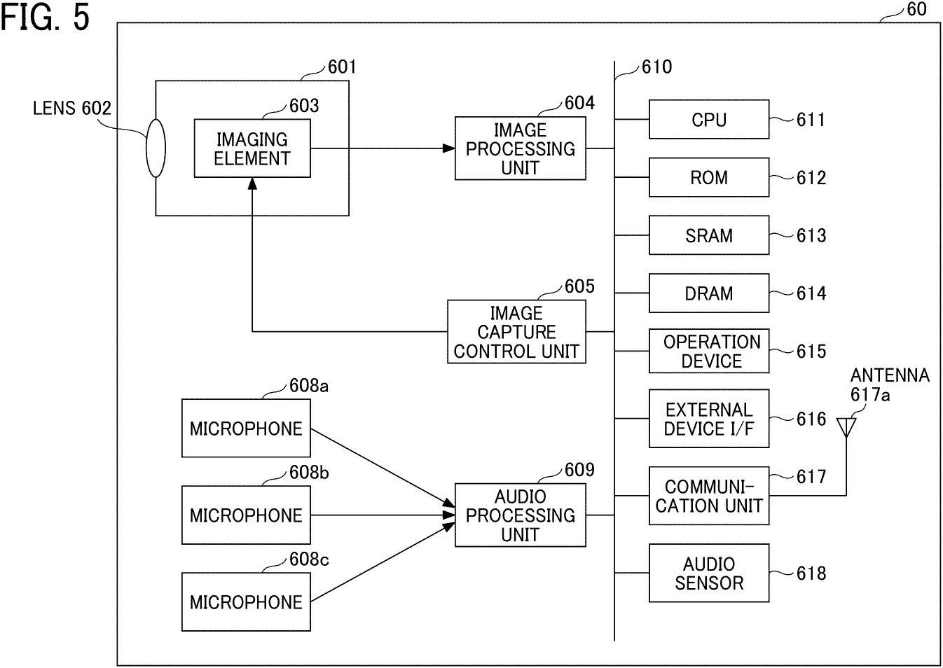

A hardware configuration of the meeting device 60 will be described with reference to FIG. 5. FIG. 5 is a block diagram illustrating an example of a hardware configuration of the meeting device 60 that can create a 360-degree video of surroundings according to the present embodiment. In the following description, the meeting device 60 is assumed to be a device that uses an imaging element to capture a 360-degree image of the surroundings of the meeting device 60 at a predetermined height, to produce a video. The number of imaging elements may be one or two or more. The meeting device 60 is not necessarily a dedicated device and may be a PC, a digital camera, a smartphone, or the like to which an imaging unit for a 360-degree video is externally attached so as to implement substantially the same functions as the meeting device 60.

As illustrated in FIG. 5, the meeting device 60 includes an imaging unit 601, an image processing unit 604. an image capture control unit 605, microphones 608a, 608b. and 608c (collectively “microphones 608”), an audio processing unit 609, a CPU 611, a ROM 612, a static random access memory (SRAM) 613, a dynamic random access memory (DRAM) 614, an operation device 615, an external device I/F 616, a communication unit 617, an antenna 617a, and an audio sensor 618. The external device I/F 616 includes a socket terminal for Micro-USB.

The imaging unit 601 includes a wide-angle lens 602 (so-called fisheye lens) having an angle of view of 360 degrees to form a hemispherical image, and an imaging element 603 (image sensor) provided for the wide-angle lens 602. The imaging element 603 includes an image sensor such as a complementary metal oxide semiconductor (CMOS) sensor or a charge coupled device (CCD) sensor, a timing generation circuit, and a group of registers. The image sensor converts an optical image formed by the wide-angle lens 602 into an electric signal to output image data. The timing generation circuit generates horizontal or vertical synchronization signals, pixel clocks, and the like for the image sensor. Various commands, parameters, and the like for operations of the imaging element are set in the group of registers.

The imaging element 603 (image sensor) of the imaging unit 601 is connected to the image processing unit 604 via a parallel I/F bus. On the other hand, the imaging element 603 of the imaging unit 601 is connected to the image capture control unit 605 via a serial I/F bus such as an inter-integrated circuit (I2C) bus. The image processing unit 604, the image capture control unit 605, and the audio processing unit 609, each of which may be implemented by a circuit, are connected to the CPU 611 via a bus 610. The ROM 612, the SRAM 613, the DRAM 614, the operation device 615, the external device I/F 616, the communication unit 617, the sound sensor 618, and the like are also connected to the bus 610.

The image processing unit 604 obtains image data output from the imaging element 603 through the parallel I/F bus and performs predetermined processing on the image data to create data of a panoramic image and data of a talker image from a fisheye image. The image processing unit 604 combines the panoramic image and the talker image or the like together to output a single video (moving image).

The image capture control unit 605 usually serves as a master device, whereas the imaging element 603 usually serves as a slave device. The image capture control unit 605 sets commands and the like in the groups of registers of the imaging element 603 through the 12C bus. The image capture control unit 605 receives the commands and the like from the CPU 611. The image capture control unit 605 obtains status data and the like in the groups of registers of the imaging element 603 through the I2C bus. The image capture control unit 605 then sends the obtained data to the CPU 611.

The image capture control unit 605 instructs the imaging element 603 to output image data at a timing when an image-capturing start button of the operation device 615 is pressed or a timing when the image capture control unit 605 receives an image-capturing start instruction from the CPU 611. In some cases, the meeting device 60 supports a preview display function and a video display function of a display (e.g.. a display of a PC or a smartphone). In this case, the image data is consecutively output from the imaging elements 603 at a predetermined frame rate (frames per minute).

When the meeting device 60 includes a plurality of imaging elements 603, the image capture control unit 605 operates in cooperation with the CPU 611 to synchronize the output timing of image data from the plurality of imaging elements 603. In the present embodiment, the meeting device 60 does not include a display. However, in some embodiments, the meeting device 60 includes a display.

The microphones 608 convert sound into audio (signal) data. The audio processing unit 609 receives the audio data output from the microphones 608a, 608b, and 608c via an I/F bus, mixes (combines) the audio data, and performs predetermined processing on the audio data. The audio processing unit 609 also determines a direction of an audio source (talker) from a level of the audio (volume) input from the microphones 608a to 608c.

The CPU 611 controls the entire operations of the meeting device 60 and performs desirable processing. The ROM 612 stores various programs for operating the meeting device 60. Each of the SRAM 613 and the DRAM 614 is a work memory and stores programs being executed by the CPU 611 or data being processed. In particular, in one example, the DRAM 614 stores image data being processed by the image processing unit 604 and processed data of an equirectangular projection image.

The operation device 615 collectively refers to various operation buttons such as an image-capturing start button. The user operates the operation device 615 to start image-capturing or recording, power on or off the meeting device 60, establish a connection, perform communication, and input settings such as various image-capturing modes and image-capturing conditions.

The external device I/F 616 is an interface for connecting various external devices. The extemal device in this case is, for example, a personal computer (PC). The video data or still image data stored in the DRAM 614 is transmitted to an external communication terminal or stored in an external medium via the external device I/F 616.

The communication unit 617 is implemented by, for example, a network interface circuit. The communication unit 617 may communicate with a cloud server via the Internet using a wireless communication technology such as Wireless Fidelity (Wi-Fi) via an antenna617a of the meeting device 60 and transmit the video data and the image data stored in the DRAM 614 to the cloud server. Further, the communication unit 617 may be able to communicate with nearby devices using a short-range wireless communication technology such as BLUETOOTH LOW ENERGY (BLE) or the near field communication (NFC).

The sound sensor 618 is a sensor that acquires 360-degree audio data in order to identify the direction from which a loud sound is input within a 360-degree space around the meeting device 60 (on a horizontal plane). The audio processing unit 609 determines the direction in which the volume of the sound is highest, based on the input 360-degree audio parameter, and outputs the direction from which the sound is input within the 360-degree space.

Note that another sensor (such as an azimuth/accelerometer or a Global Positioning System (GPS)) may calculate an azimuth, a position, an angle, an acceleration, or the like and use the calculated azimuth, position, angle, acceleration, or the like in image correction or position information addition.

The image processing unit 604 generates a panoramic image in the following method. The CPU 611 performs predetermined camera image processing such as Bayer interpolation (red green blue (RGB) supplementation processing) on raw data input by an image sensor that inputs a spherical image, to generate a wide-angle image (a video including curved-surface images). Further, the CPU 611 performs unwrapping processing (distortion correction processing) on the wide-angle image lens (the video including curved-surface images) to generate a panoramic image (a video including planar images) of the surroundings in 360 degrees around the meeting device 60.

The CPU 611 creates a talker image according to a method below. The CPU 611 generates a talker image on which a talker is cut out from a panoramic image (a video including planar images) of the surroundings in 360 degrees around the meeting device 60. The CPU 611 cuts out, from the panoramic image, a talker image corresponding the direction of the talker which is the input direction of the audio determined from 360 degrees, using the audio sensor 618 and the audio processing unit 609. For cutting out an image of a person based on the input direction of the audio, specifically, the CPU 611 cuts out a 30-degree portion around the input direction of the audio identified from 360 degrees, and performs face detection on the 30-degree portion to cut out the talker image. The CPU 611 further identifies talker images of a predetermined number of persons (e.g., three persons) who have most recently spoken, among talker images cut out from the panoramic image.

The panoramic image and one or more talker images may be individually transmitted to the information recording application 41. Alternatively, the meeting device 60 may create one image combined from the panoramic image and the one or more talker images and transmit the one image to the information recording application 41. In the present embodiment, the panoramic image and one or more talker images are individually transmitted from the meeting device 60 to the information recording application 41.

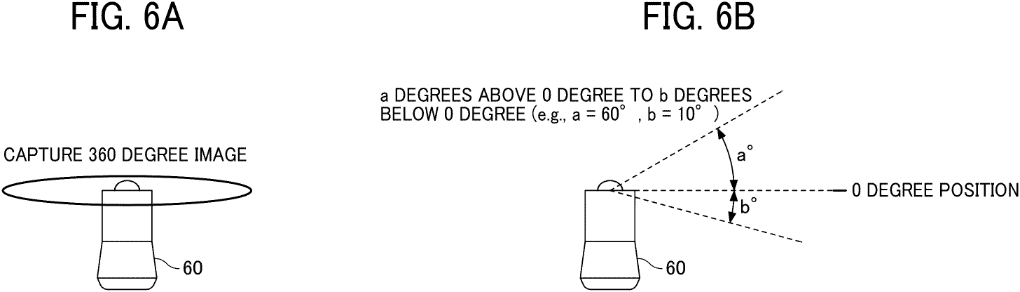

FIG. 6A and FIG. 6B are diagrams illustrating an image capture range of the meeting device 60. As illustrated in FIG. 6A,the meeting device 60 captures an image of a 360-degree range in the horizontal direction. As illustrated in FIG. 6B, the meeting device 60 has an image capture range extending predetermined angles up and down from a 0-degree direction that is horizontal to the height of the meeting device 60.

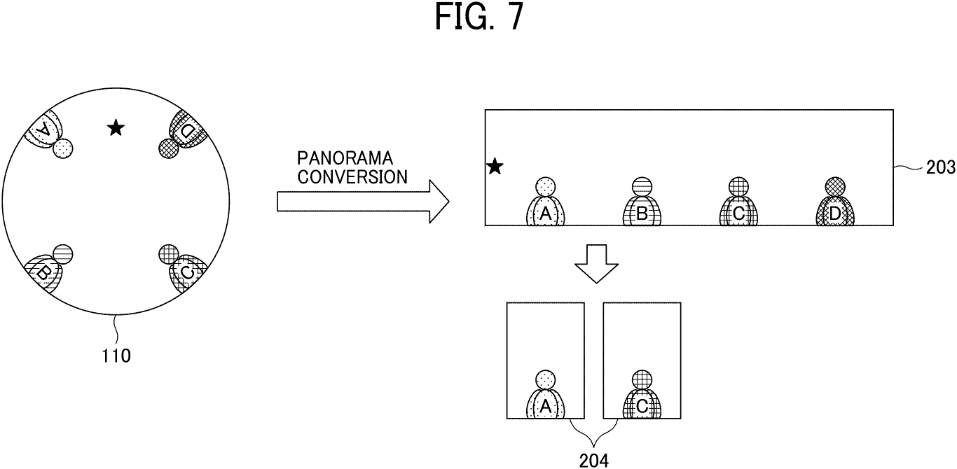

FIG. 7 is a schematic diagram illustrating a panoramic image and cutting out talker images from the panoramic image. As illustrated in FIG. 7, an image captured by the meeting device 60 is a portion 110 of a sphere, and thus has a three-dimensional shape. As illustrated in FIG. 6B, the meeting device 60 divides angles of view into the predetermined degrees up and down and by the predetermined angle in the horizontal direction to perform perspective projection conversion on each of the angles of view. A predetermined number of planar images are obtained by performing the perspective projection conversion on the entire 360-degree range in the horizontal direction without gaps. Thus, a panoramic image 203 is obtained by laterally connecting the predetermined number of planar images. The meeting device 60 performs face detection on a predetermined range around the sound direction in the panoramic image 203, and clips 15-degree leftward and rightward ranges from the center of the face (i.e., a 30-degree range in total) to create a talker image 204.

### Electronic Whiteboard

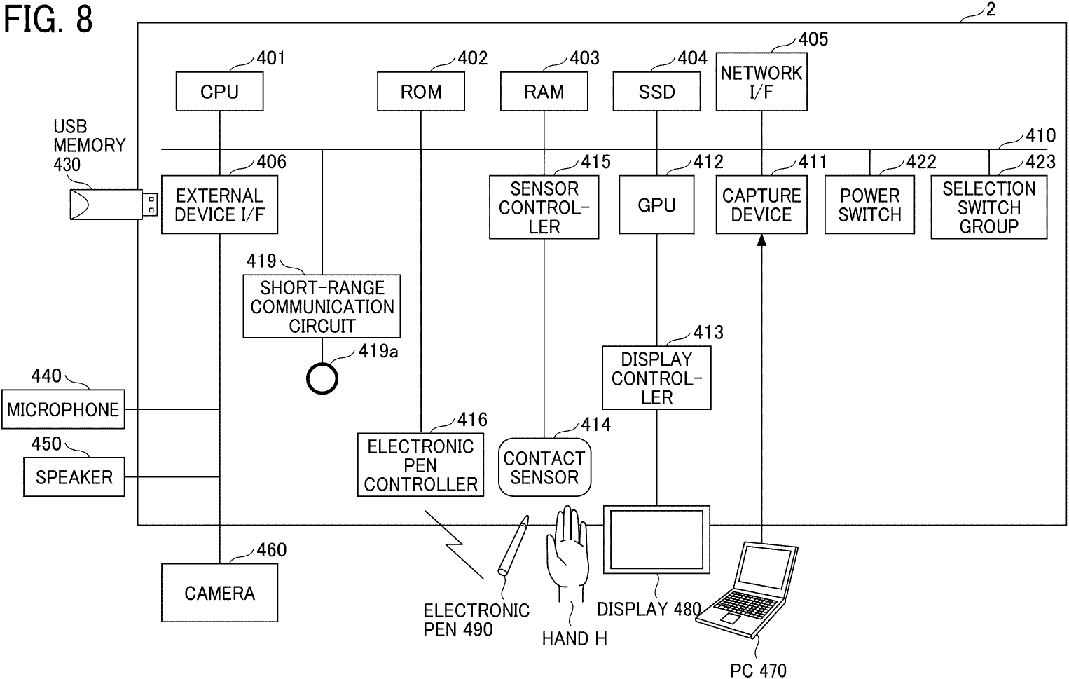

FIG. 8 is a diagram illustrating an example of a hardware configuration of the electronic whiteboard 2. As illustrated in FIG. 8, the electronic whiteboard 2 includes a CPU 401, a ROM 402, a RAM 403, a solid state drive (SSD) 404, a network I/F 405, and an external device I/F 406.

The CPU 401 controls operations of the entire electronic whiteboard 2. The ROM 402 stores a program such as an IPL to boot an operating system (OS). The RAM 403 is used as a work area for the CPU 401. The SSD 404 stores various kinds of data such as a program for the electronic whiteboard 2. The network I/F 405 controls communication with a communication network. The external device I/F 406 is an interface for connecting various external devices. Examples of the external devices in this case include, but not limited to, a USB memory 430 and externally-connected devices such as a microphone 440, a speaker 450, and a camera 460.

The electronic whiteboard 2 further includes a capture device 411, a graphics processing unit (GPU) 412, a display controller 413, a contact sensor 414, a sensor controller 415, an electronic pen controller 416, a short-range communication circuit 419, an antenna 419a of the short-range communication circuit 419, a power switch 422, and a selection switch group 423.

The capture device 411 causes a display of an external PC 470 to display a still image or a video based on image data captured by the capturing device. The GPU 412 is a semiconductor chip that exclusively handles graphics. The display controller 413 controls and manages displaying of a screen to display an image output from the GPU 412 on a display 480. The contact sensor 414 detects a touch of an electronic pen 490, a user’s hand H, or the like onto the display 480. The sensor controller 415 controls processing of the contact sensor 414. The contact sensor 414 receives a touch input and detects coordinates of the touch input according to the infrared blocking system. The inputting and detecting a coordinate may be as follows. For example, two light receiving and emitting devices are disposed at both ends of the upper face of the display 480, and a reflector frame surrounds the periphery of the display 480. The light receiving and emitting devices emit a plurality of infrared rays in parallel to a surface of the display 480. The rays are reflected by the reflector frame, and a light-receiving element receives light returning through the same optical path of the emitted infrared rays. The contact sensor 414 outputs, to the sensor controller 415, position information (a position on the light-receiving elements) of an infrared ray that is emitted from the two light receiving and emitting devices and then blocked by an object. Based on the position information of the infrared ray, the sensor controller 415 detects specific coordinates of the position touched by the object. The electronic pen controller 4 1 6 communicates with the electronic pen 490 by BLUETOOTH to detect a touch by the tip or bottom of the electronic pen 490 to the display 480. The short-range communication circuit 419 is a communication circuit that is compliant with Near Field Communication (NFC), BLUETOOTH, or the like. The power switch 422 is used for powering on and off the electronic whiteboard 2. The selection switch group 423 is a group of switches for adjusting brightness, hue, etc., of display on the display 480.

The electronic whiteboard 2 further includes a bus line 410. The bus line 410 is, for example, an address bus or a data bus for electrically connecting the components such as the CPU 401 illustrated in FIG. 8 to one another.

Note that the contact sensor 414 is not limited to a touch sensor of the infrared blocking system, and may be a capacitive touch panel that detects a change in capacitance to identify the touched position. The contact sensor 414 may be a resistive-film touch panel that identifies the touched position based on a change in voltage across two opposing resistive films. The contact sensor 414 may be an electromagnetic inductive touch panel that detects electromagnetic induction generated by a touch of an object onto a display to identify the touched position. In addition to the devices described above, various types of detection devices may be used as the contact sensor 414. The electronic pen controller 416 may determine whether there is a touch of another part of the electronic pen 490 such as a part of the electronic pen 490 held by the user as well as the tip and the bottom of the electronic pen 490.

### Functions

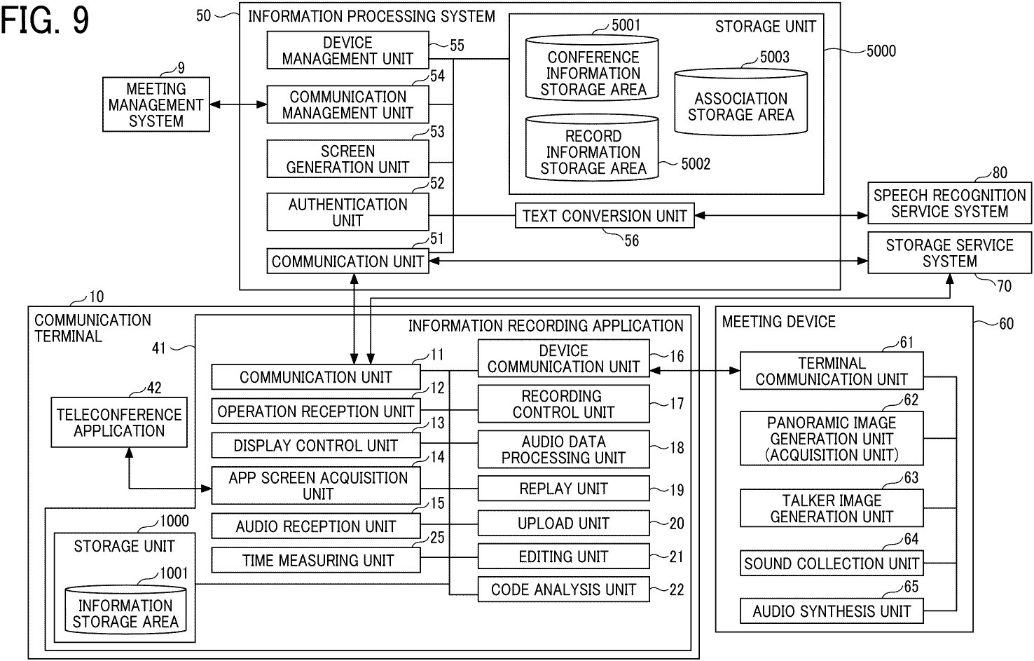

A description is now given of a functional configuration of the record creation system 100, with reference to FIG. 9. FIG. 9 is a block diagram illustrating functional configurations of the communication terminal 10, the meeting device 60, and the information processing system 50 of the record creation system 100 according to the present embodiment.

### Communication Terminal

The information recording application 41 operating on the communication terminal 10 implements a communication unit 11, an operation reception unit 12, a display control unit 13, an app screen acquisition unit 14, an audio reception unit 15, a device communication unit 16, a recording control unit 17. an audio data processing unit 18. a replay unit 19, an upload unit 20. an editing unit 21, a code analysis unit 22, and a time measuring unit 25. These units of functions on the communication terminal 10 are implemented by or caused to function by one or more of the components illustrated in FIG. 4 operating in accordance with instructions from the CPU 501 according to the information recording application 41 loaded from the HD 504 to the RAM 503. The communication terminal 10 also includes a storage unit 1000 implemented by the HD 504 or the like illustrated in FIG. 4. The storage unit 1000 includes an information storage area 1001, which is implemented by a database, for example.

The communication unit 11 transmits and receives various types of information to and from the information processing system 50 via a communication network.

For example, the communication unit 11 receives a list of teleconferences from the information processing system 50 and transmits an audio data recognition request to the information processing system 50.

The display control unit 13 control display of various screens serving as user interfaces in the information recording application 41 in accordance with screen transitions set in the information recording application 41. The operation reception unit 12 receives various operations input to the information recording application 41.

The app screen acquisition unit 14 acquires a desktop screen or a screen displayed by an application selected by a user from an operating system (OS) or the like. When the application selected by the user is the teleconference application 42. a screen (including e.g., an image of each site and an image of a material or document displayed) generated by the teleconference application 42 is obtained.

The audio reception unit 15 acquires audio data received by the communication terminal 10 from the teleconference application 42 in a teleconference. Note that the audio data acquired by the audio reception unit 15 does not include sound collected by the communication terminal 10. This is because the meeting device 60 collects sound.

The device communication unit 16 communicates with the meeting device 60 using a USB cable or the like. Alternatively, the device communication unit 16 may communicate with the meeting device 60 via a wireless local area network (LAN) or BLUETOOTH. The device communication unit 16 receives the panoramic image and the talker image from the meeting device 60. and transmits the audio data acquired by the audio reception unit 15 to the meeting device 60. The device communication unit 16 receives the audio data combined by the meeting device 60.

The recording control unit 17 combines the panoramic image and the talker image received by the device communication unit 16 and the screen of the application acquired by the app screen acquisition unit 14 together, to create a combined image. The recording control unit 17 connects the repeatedly created combined images in time series to create a combined video, and attaches the audio data combined by the meeting device 60 to the combined video, to create a combined video with sound.

The audio data processing unit 18 requests the information processing system 50 to convert, into text data, the audio data extracted by the recording control unit 17 from the combined video with sound or the combined audio data received from the meeting device 60.

The replay unit 19 plays the combined video. The combined video is stored in the communication terminal 10 during recording, and then uploaded to the information processing system 50.

After the teleconference ends, the upload unit 20 transmits the combined video to the information processing system 50.

The editing unit 21 edits the combined video (e.g., deletes a portion of the combined video or combines a plurality of combined videos) in accordance with a user operation.

The code analysis unit 22 detects a two-dimensional code included in the panoramic image and analyzes the two-dimensional code to acquire a device ID.

The time measuring unit 25 measures the time from when the information recording application 41 is activated to when the two-dimensional code is received from the meeting device 60. When a predetermined time has elapsed, the time measuring unit 25 notifies the display control unit 13 of the elapse of the predetermined time, and the display control unit 13 displays an error dialog.

FIG. 10 illustrates example items of information on the recorded video, stored in the information storage area 1001. The information on the recorded video includes items such as “conference ID.” “recording ID,” “update date/time,” “title,” “upload,” and “storage location.” When a user logs into the information processing system 50, the information recording application 41 downloads conference information from a conference information storage area 5001 of the information processing system 50. The conference ID or the like included in the conference information is reflected in the information on the recorded video. The information on the recorded video in FIG. 10 is stored by the communication terminal 10 operated by a certain user.

The item “conference ID” is identification information identifying a held teleconference (communication identifier identifying a communication). The conference ID is assigned when a schedule of the teleconference is registered to a conference management system 9, or is assigned by the information processing system 50 in response to a request from the information recording application 41.

The item “recording ID” is identification information identifying a combined video recorded during the teleconference.

The recording ID is assigned by the meeting device 60, but may be assigned by the information recording application 41 or the information processing system 50. Different recording IDs are assigned to a same conference ID in a case where the recording is suspended in the middle of the teleconference but is started again for some reason.

The item “update date/time” represents the date and time when the combined video is updated (or recording is ended). When the combined video is edited, the update date and time is the date and time of editing.

The item “title” is a name of the conference. The title may be set when the conference is registered to the conference management system 9, or may be set by the user in any manner.

The item “uploaded” indicates whether the combined video has been uploaded to the information processing system 50.

The item “storage location” indicates a location, such as uniform resource locator (URL) or file path, where the combined video and the text data are stored in the storage service system 70. The item “storage location” allows the user to view the uploaded combined video as desired. Note that the combined video and the text data are stored with different file names following the URL, for example.

### Meeting Device

Referring back to FIG. 9, the description is continued. The meeting device 60 includes a terminal communication unit 61, a panoramic image generation unit 62 (acquisition unit), a talker image generation unit 63, a sound collection unit 64, and an audio synthesis unit 65. These functional units of the meeting device 60 are implemented by or caused to function by one or more of the components illustrated in FIG. 5 operating in accordance with instructions from the CPU 611 according to the control program loaded from the ROM 612 to the DRAM 614.

The terminal communication unit 61 communicates with the communication terminal 10 using a USB cable or the like. The connection of the terminal communication unit 61 to the communication terminal 10 is not limited to a wired cable, but includes connection by a wireless LAN, BLUETOOTH, or the like.

The panoramic image generation unit 62 generates a panoramic image. The talker image generation unit 63 generates a talker image. The method of generating a panoramic image and a talker image has been described with reference to FIGS. 6A to 7. The panoramic image generation unit 62 also serves as an acquisition unit that acquires image data.

The sound collection unit 64 converts sound received by the microphone of the meeting device 60 into audio data (digital data). Thus, the utterances (speeches) made by the user and the participants at the site where the communication terminal 10 is installed are collected.

The audio synthesis unit 65 combines the audio data transmitted from the communication terminal 10 and the sound collected by the sound collection unit 64. Accordingly, the speeches uttered at the second site 101 and those uttered at the first site 102 are combined.

### Information Processing System

The information processing system 50 includes a communication unit 51, an authentication unit 52, a screen generation unit 53, a communication management unit 54, a device management unit 55, and a text conversion unit 56. These functional unit of the information processing system 50 are implemented by or caused to function by one or more of the components illustrated in FIG. 4 operating in accordance with instructions from the CPU 501 according to the control program loaded from the HD 504 to the RAM 503. The information processing system 50 also includes a storage unit 5000 implemented by the HD 504 or the like illustrated in FIG. 4. The storage unit 5000 includes the conference information storage area 5001, a record information storage area 5002, and an association storage area 5003 each of which is implemented by a database, for example.

The communication unit 51 transmits and receives various kinds of information to and from the communication terminal 10. For example, the communication unit 51 transmits a list of teleconferences to the communication terminal 10, and receives a request of speech recognition on audio data from the communication terminal 10.

The authentication unit 52 authenticates a user who operates the communication terminal 10. For example, the authentication unit 52 authenticates a user based on whether authentication information (a user ID and a password) included in an authentication request received by the communication unit 51 matches authentication information held in advance. The authentication information may be a card number of an integrated circuit (IC) card, biometric authentication information of a face, a fingerprint, or the like. The authentication unit 52 may use an external authentication system or an authentication method such as Open Authorization (OAuth) to perform authentication.

The screen generation unit 53 generates screen information representing a screen to be displayed with a web application by the communication terminal 10. The screen information is described in Hyper Text Markup Language (HTML), Extended Markup Language (XML), Cascade Style Sheet (CSS), or JAVASCRIPT, for example.

The communication management unit 54 acquires information related to a teleconference from the conference management system 9 by using an account of each user or a system account assigned to the information processing system 50. The communication management unit 54 stores conference information of a scheduled conference in association with a conference ID in the conference information storage area 5001. The communication management unit 54 acquires conference information for which a user belonging to the tenant has a right to view. Since the conference ID is set for a conference, the teleconference and the record are associated with each other by the conference ID.

In response to receiving device IDs of the electronic whiteboard 2 and the meeting device 60 to be used in the conference, the device management unit 55 stores these device IDs, in association with the teleconference, in the association storage area 5003. Accordingly, the conference ID, the device ID of the electronic whiteboard 2, and the device ID of the meeting device 60 are associated with each other. Since the combined video is also associated with the conference ID. the hand-drafted data input on the electronic whiteboard 2 is also associated with the combined video. In response to the end of recording (the end of the conference), the device management unit 55 deletes the association from the association storage area 5003.

The text conversion unit 56 uses the external speech recognition service system 80 to convert, into text data, audio data requested to be converted into text data by the communication terminal 10. In some embodiments, the text conversion unit 56 may perform this conversion.

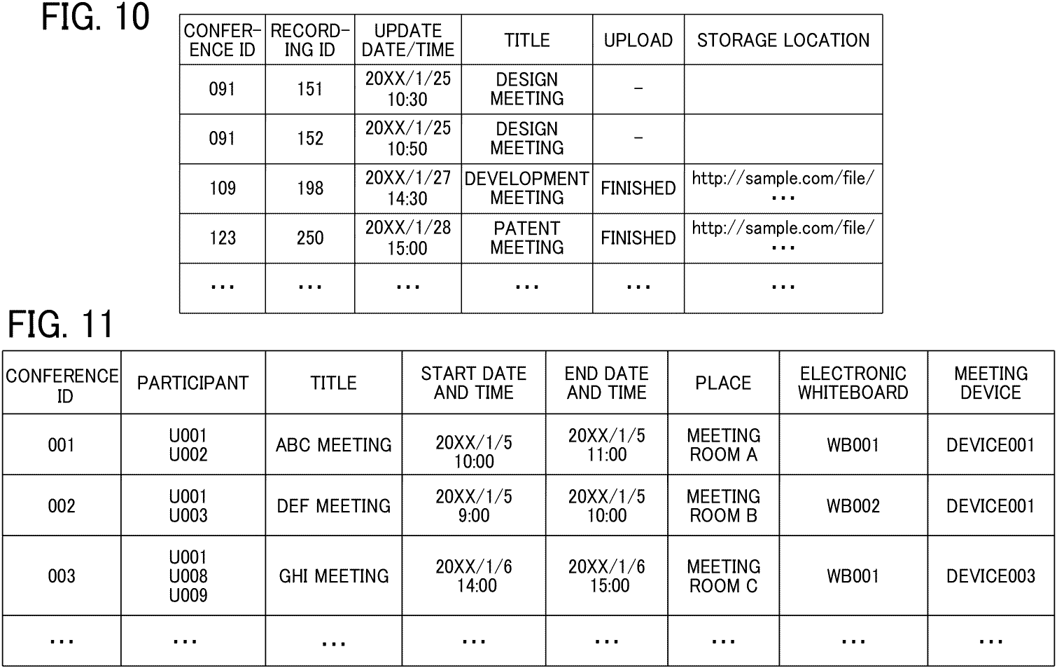

FIG. 11 illustrates an example of conference information stored in the conference information storage area 5001 and managed by the communication management unit 54. The communication management unit 54 uses the aforementioned account to acquire a list of teleconferences for which a user belonging to a tenant has a right to view. In the present embodiment, teleconferences are used as an example. However, the list of teleconferences also includes a conference held in a single conference room.

The conference information is managed with the conference ID, which is associated with the items “participant,” “title,” “start date and time,” “end date and time,” “place,” and the like. These items are an example of the conference information, and the conference information may include other information.

The item “participant” represents participants of the conference.

The item “title” represents a content of the conference such as a name of the conference or an agenda of the conference.

The item “start date and time” indicates a date and time at which the conference is scheduled to be started.

The item “end date and time” indicates a date and time at which the conference is scheduled to end.

The item “place” represents a place where the conference is held such as a name of a conference room, a name of a branch office, or a name of a building.

The item “electronic whiteboard” represents a device ID of the electronic whiteboard 2 used in the conference.

The item “meeting device” indicates identification information of the meeting device 60 used in the conference.

As illustrated in FIGS. 10 and 11, a combined video recorded at a conference is identified by the conference ID.

The information on the recorded video stored in the record information storage area 5002 may be the same as the information illustrated in FIG. 10. However, the information processing system 50 has a list of combined videos recorded by all users belonging to the tenant.

FIG. 12 illustrates an example of association information associating a conference ID with the device IDs of the electronic whiteboard 2 and the meeting device 60. The association information is stored in the association storage area 5003. The association information is held from when the information recording application 41 transmits the device ID to the information processing system 50 to when the recording ends.

### Electronic Whiteboard

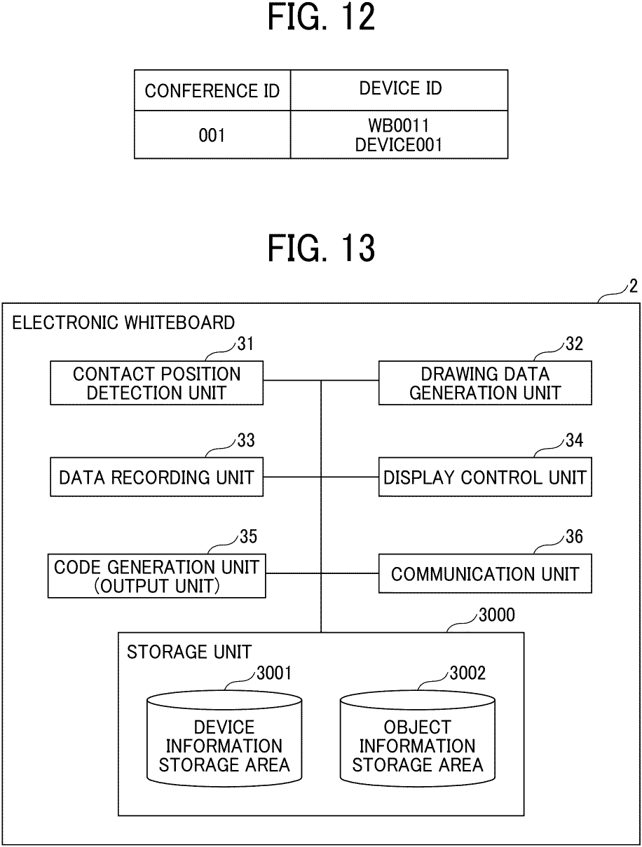

FIG. 13 is a block diagram illustrating functional configurations of the electronic whiteboard 2 according to the present embodiment. The electronic whiteboard 2 includes a contact position detection unit 31, a drawing data generation unit 32, a data recording unit 33, a display control unit 34, a code generation unit 35 (output unit), and a communication unit 36. The respective functions of the electronic whiteboard 2 are functions or means that are implemented by one or more of the components illustrated in FIG. 8 obeying instructions from the SSD 404 according to a program loaded to the RAM 403 from the CPU 401.

The contact position detection unit 31 detects coordinates of a position where the electronic pen 490 has touched the contact sensor 414. The drawing data generation unit 32 acquires the coordinates of the position touched by the tip of the electronic pen 490 from the contact position detection unit 31. The drawing data generation unit 32 interpolates a sequence of coordinate points and links the resulting coordinate points to generate stroke data.

The display control unit 34 displays hand-drafted data, a menu to be operated by the user, and the like on the display.

The data recording unit 33 stores, in an object information storage area 3002, information on hand-drafted data hand-drawn on the electronic whiteboard 2, a graphic such as a circle or triangle, a stamp of “DONE” or the like, a PC screen, and a file. Each of the hand-drafted data, the graphic, the image such as a PC screen, and the file is treated as an object. Regarding handwritten data, a set of stroke data grouped is stored as one object. Grouping is made by time due to interruption of input of handwriting or by the position where the handwriting is input.

The communication unit 36 is connected to Wi-Fi or a LAN and communicates with the information processing system 50. The communication unit 36 transmits object information to the information processing system 50. receives object information stored in the information processing system 50 from the information processing system 50, and displays object based on the object information on the display 480.

The code generation unit 35 encodes the device ID of the electronic whiteboard 2 stored in a device information storage area 3001 and information indicating that the device is usable in the conference into a two-dimensional pattern, to generate a two-dimensional code. The code generation unit 35 may encode, into a barcode, the device ID of the electronic whiteboard 2 and the information indicating that the electronic whiteboard 2 is a device usable in the conference. The device ID is, for example, either a serial number or a universally unique identifier of the electronic whiteboard 2. The device identification information may be set by the user. Note that the code generation unit 35 also serves as an output unit that outputs a two-dimensional code or a barcode.

The electronic whiteboard 2 also includes a storage unit 3000 implemented by the SSD 404 or the like illustrated in FIG. 8. The storage unit 3000 includes the device information storage area 3001 and the object information storage area 3002 each of which is implemented by a database, for example.

FIG. 14 illustrates information such as device ID stored in the device information storage area 3001.

The item “device ID” is identification information identifying the electronic whiteboard 2.

The item “Internet Protocol (IP) address” is used by another device to connect to the electronic whiteboard 2 via a network.

The item “password” is used for authentication performed when another apparatus connects to the electronic whiteboard 2.

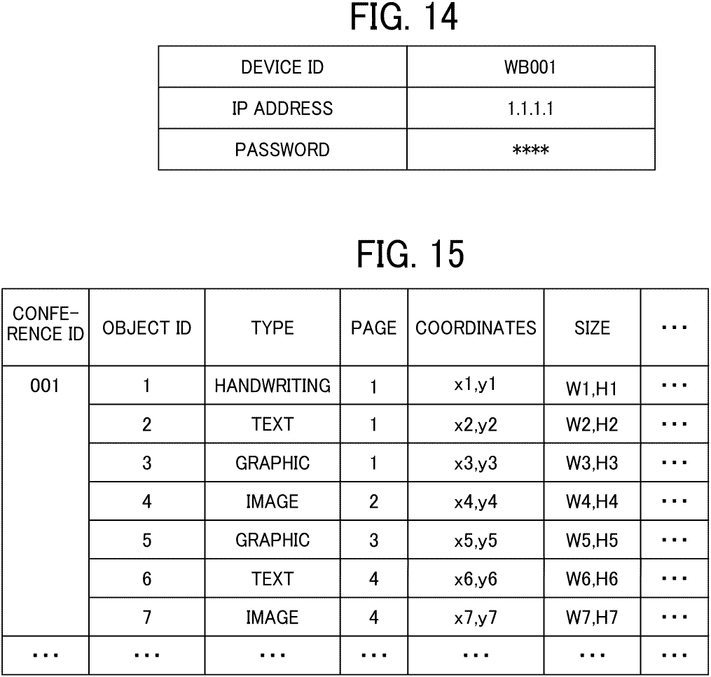

FIG. 15 illustrates an example of object information stored in the object information storage area 3002 according to the present embodiment. The object information is information for managing an object displayed by the electronic whiteboard 2. The object information is transmitted to the information processing system 50 and is used as minutes.

In a case where the electronic whiteboard 2 is located at the second site when the teleconference is held, the object information is shared with the first site.

The item “conference ID” indicates identification information of a conference notified from the information processing system 50.

The item “object ID” indicates identification information for identifying an object.

The item “type” indicates a type of the object. the type of object includes, for example, handwriting, text, graphic, and image. “Handwriting” represents stroke data (coordinate point sequence). “Text” represents a character string (character codes) input from a software keyboard. The character string may also be referred to as text data. “Graphic” is a geometric shape such as a triangle or a quadrangle. “Image” represents image data in a format such as Joint Photographic Experts Group (JPEG), Portable Network Graphics (PNG), or Tagged Image File Format (TIFF) acquired from, for example, a PC or the Internet.

A single screen of the electronic whiteboard 2 is referred to as a page. A “page” indicates the page number.

The item “coordinates” indicate a position of an object relative to a predetermined origin on the electronic whiteboard 2. The position of the object is, for example, the upper left vertex of a circumscribed rectangle of the object. The coordinates are expressed, for example, in units of pixels of the display.

The item “size” indicates a width and a height of the circumscribed rectangle of the object.

### Screen Transition

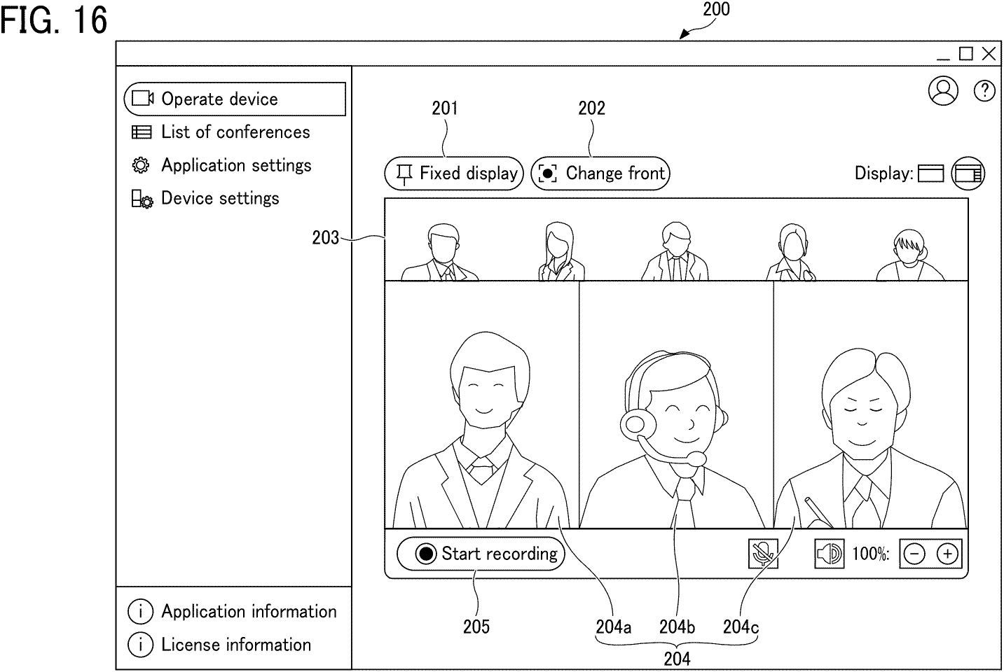

Descriptions are now given of several screens displayed by the communication terminal 10 in a teleconference, with reference to FIGS. 16 to 19. FIG. 16 is a diagram illustrating an example of an initial screen 200 displayed by the information recording application 41 operating on the communication terminal 10 after a login. The user of the communication terminal 10 connects to the information processing system 50 on the information recording application 41. The user inputs authentication information, and when the login is successful, the initial screen 200 of FIG. 16 is displayed.

The initial screen 200 includes a fixed display button 201, a change front button 202, the panoramic image 203, one or more talker images 204a to 204c, and a start recording button 205. In the following description, each of the talker images 204a to 204c may be simply referred to as a “talker image 204,” when not distinguished from each other. In a case where the meeting device 60 has already been started and is capturing an image of the surroundings at the time of the login, the panoramic image 203 and the talker images 204 created by the meeting device 60 are displayed on the initial screen 200. This allows the user to decide whether to start recording while viewing the panoramic image 203 and the talker images 204. In a case where the meeting device 60 is not started (is not capturing any image), the panoramic image 203 and the talker images 204 are not displayed.

The information recording application 41 may display the talker images 204 of all participants based on all faces detected from the panoramic image 203, or may display the talker images 204 of certain number (N) of persons who have made an utterance most recently. In the example illustrated in FIG. 16,the talker images 204 of up to three persons are displayed. Display of the talker image 204 of a participant may be omitted until one of the participants makes an utterance (in this case, the number of the talker images 204 increases by one in response to an utterance). Alternatively, the talker images 204 of three participants in a predetermined direction may be displayed (the talker images 204 are switched in response to an utterance).

When no participant is speaking such as immediately after the meeting device 60 is turned on, an image of a predetermined direction (such as 0 degrees, 120 degrees, or 240 degrees) of 360 degrees in the horizontal direction is generated as the talker image 204. When fixed display (described later) is set, the setting of the fixed display is prioritized.

The fixed display button 201 is a button for the user to perform an operation of fixing a certain area of the panoramic image 203 as the talker image 204 in close-up.

The change front button 202 is a button for the user to perform an operation of changing the front of the panoramic image 203. Since the panoramic image presents the 360-degree surroundings in the horizontal direction, the right end and the left end matches to the same direction. The user slides the panoramic image 203 leftward or rightward with a pointing device to set a particular participant to the front. The user’s operation is transmitted to the meeting device 60. The meeting device 60 changes the angle set as the front in 360 degrees in the horizontal direction, creates the panoramic image 203, and transmits the panoramic image 203 to the communication terminal 10.

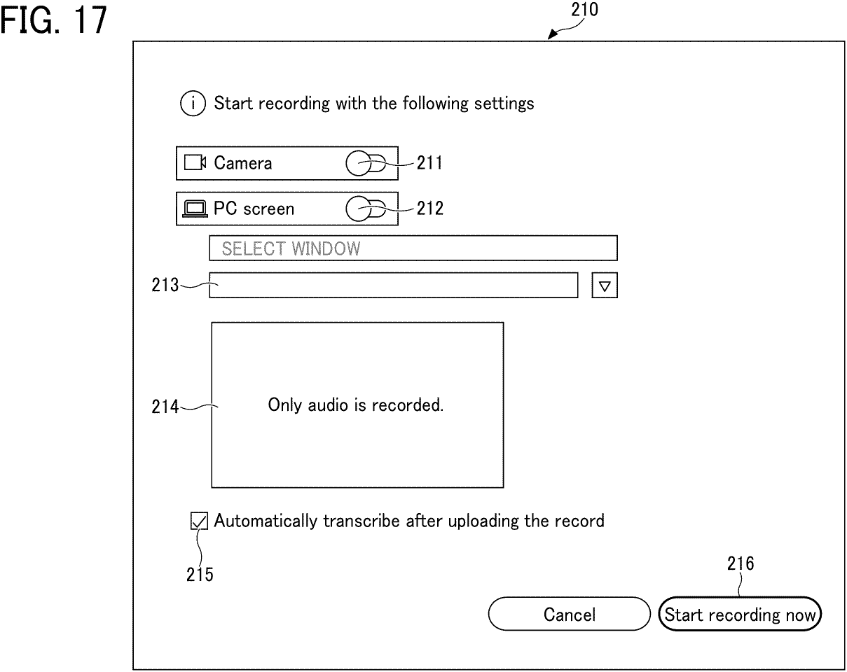

When the user presses the start recording button 205, the information recording application 41 displays a recording setting screen 210 illustrated in FIG. 17.

FIG. 17 is a diagram illustrating an example of the recording setting screen 210 displayed by the information recording application 41. The recording setting screen 210 allows the user to set whether to record (whether to include in a recorded video) the panoramic image 203 and the talker images 204 created by the meeting device 60 and the desktop screen of the communication terminal 10 or the screen of the application operating on the communication terminal 10. In a case where the information recording application 41 is set to record none of the panoramic image, the talker image, and the desktop screen or the screen of the operating application, the information recording application 41 records only audio (audio output by the communication terminal 10 and audio collected by the meeting device 60).

A camera toggle button 211 is a button for switching on and off of recording of the panoramic image and the talker image generated by the meeting device 60. Alternatively, the camera toggle button 211 may allow settings for switching on and off of recording of the panoramic image and the talker image individually.

A PC screen toggle button 212 is a button for switching on and off of recording of the desktop screen of the communication terminal 10 or a screen of an application operating on the communication terminal 10. When the PC screen toggle button 212 is on, the desktop screen is recorded.

When the user desires to record the screen of the application, the user further selects the application in an application selection field 213. In the application selection field 213, names of applications operating on the communication terminal 10 are displayed in a pull-down format. Thus, the application selection field 213 allows the user to select an application whose screen is to be recorded. The information recording application 41 acquires the names of the applications from the OS. The information recording application 41 can display names of applications that have a user interface (UI) (screen) among applications being executed. The applications to be selected may include the teleconference application 42. Thus, the information recording application 41 can record a material displayed by the teleconference application 42, the participant at each site, and the like as a video. In addition, various applications such as a presentation application, a word processor application, a spreadsheet application, and a Web browser application are displayed in a pull-down manner. This thus allows the user to flexibly select the screen of the application to be included in the combined video.

When recording is performed in units of applications, the user is allowed to select a plurality of applications. The information recording application 41 can record the screens of all the selected applications.

When both the camera toggle button 211 and the PC screen toggle button 212 are set to off, a message “Only audio is recorded” is displayed in a recorded content confirmation window 214. The audio in this case includes audio output from the communication terminal 10 (audio received by the teleconference application 42 from the second site 101) and audio collected by the meeting device 60. That is, when a teleconference is being held, the audio from the teleconference application 42 and the audio from the meeting device 60 are stored regardless of whether the images are recorded. Note that the user may make a setting to selectively stop storing the sound from the teleconference application 42 and the sound from the meeting device 60 according to user settings.

In accordance with a combination of on and off of the camera toggle button 211 and the PC screen toggle button 212, a combined video is recorded in the following manner. The combined video is displayed in real time in the recorded content confirmation window 214.

In a case where the camera toggle button 211 is on and the PC screen toggle button 212 is off, the panoramic image and the talker images created by the meeting device 60 are displayed in the recorded content confirmation window 214.

If the camera toggle button 211 is off and the PC screen toggle button 212 is on (and the screen has also been selected), the desktop screen or the screen of the selected application is displayed in the recorded content confirmation window 214.

In a case where the camera toggle button 211 is on and the PC screen toggle button 212 is on, the panoramic image and the talker images created by the meeting device 60 and the desktop screen or the screen of the selected application are displayed side by side in the recorded content confirmation window 214.

Thus, an image created by the information recording application 41 is referred to as a combined video for convenience in the present embodiment although there is a case where the panoramic image and the talker images or the screen of the application is not recorded or a case where none of the panoramic image, the talker image, and the screen of the application are recorded.

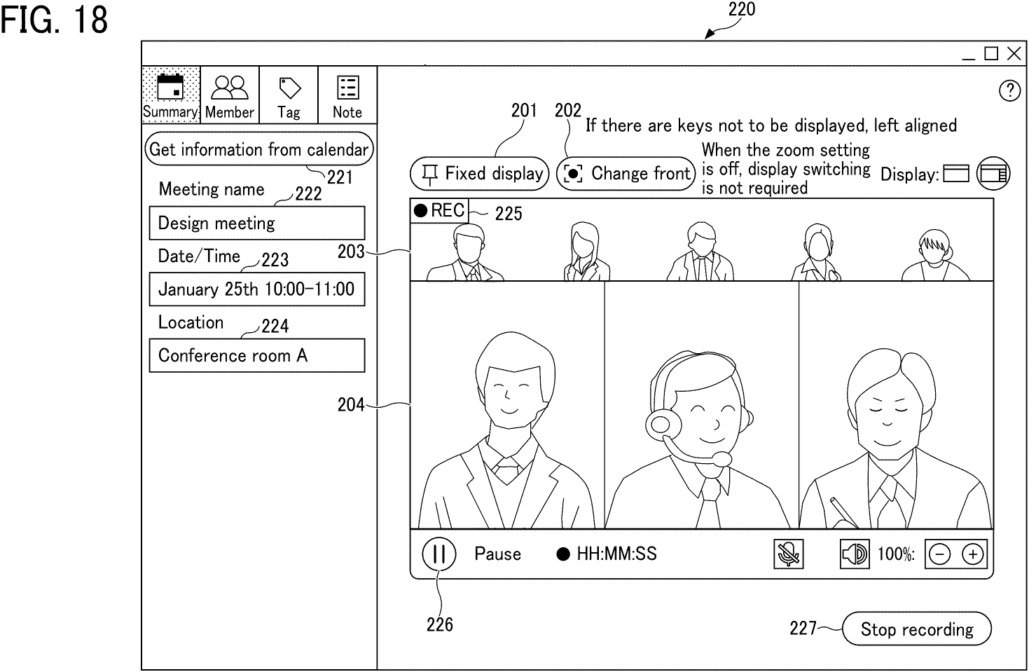

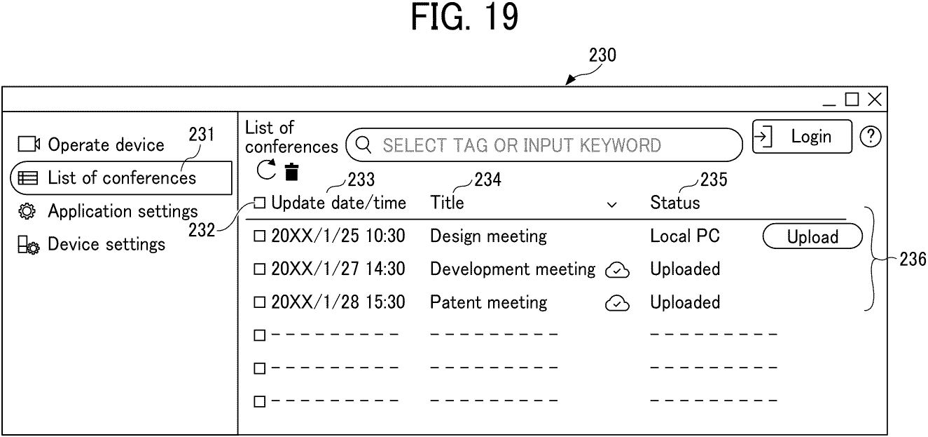

The recording setting screen 210 further includes a check box 215 labelled as “automatically transcribe after uploading the record.” The recording setting screen 210 further includes a button 216 labelled as “start recording now.” If the user checks the check box 215, text data converted from utterances made during the teleconference is attached to the recorded video. In this case, after the end of recording, the information recording application 41 uploads audio data to the information processing system 50 together with a text data conversion request. When the user presses the button 216 labelled as “start recording now,” a recording-in-progress screen 220 is displayed as illustrated in FIG. 18.

FIG. 18 is an example of the recording-in-progress screen 220 displayed by the information recording application 41 during recording. In the description referring to FIG. 18,for simplicity, mainly differences from FIG. 16 are described. The recording-in-progress screen 220 displays, in real time, the combined video being recorded according to the conditions set by the user in the recording setting screen 210. The recording-in-progress screen 220 in FIG. 18 corresponds to the case where the camera toggle button 211 is on and the PC screen toggle button 212 is off, and displays the panoramic image 203 and the talker images 204 (both are moving images) created by the meeting device 60. The recording-in-progress screen 220 includes a recording icon 225, a pause button 226. and a stop recording button 227.

The pause button 226 is a button for pausing the recording. The pause button 226 also receives an operation of resuming the recording after the recording is paused. The stop recording button 227 is a display component (visual representation) for receiving an instruction for ending the recording. The recording ID is does not changed when the pause button 226 is pressed, whereas the recording ID is changed when the stop recording button 227 is pressed. After pausing or temporarily stopping the recording, the user allowed to set the recording conditions set in the recording setting screen 210 again before resuming the recording or starting recording again. In this case, the information recording application 41 may generate multiple video files each time the recording is stopped (e.g., when the stop recording button 227 is pressed), or may consecutively combine the plurality of video files to generate a single video (e.g., when the pause button 226 is pressed). When the information recording application 41 plays the combined video, the information recording application 41 may play the plurality of recorded files continuously as one video.

The recording-in-progress screen 220 includes a button 221 labelled as “get information from calendar,” a conference name field 222, a time field 223, and a location field 224. The button 221 labelled as “get information from calendar” allows the user to acquire conference information from the conference management system 9. When the user presses the button 221 labelled as “get information from calendar,” the information recording application 41 acquires a list of conferences for which the user has a viewing authority from the information processing system 50 and displays the acquired list of conferences. The user selects a teleconference to be held from the list of conferences. Consequently, the conference information is reflected in the conference name field 222, the time field 223, and the location field 224. The title, the start time and the end time, and the location included in the conference information are reflected in the conference name field 222, the time field 223, and the location field 224, respectively. The conference information and the record in the conference management system 9 are associated with each other by the conference ID.

In response the user ending the recording after the end of the teleconference, a combined video with sound is created.

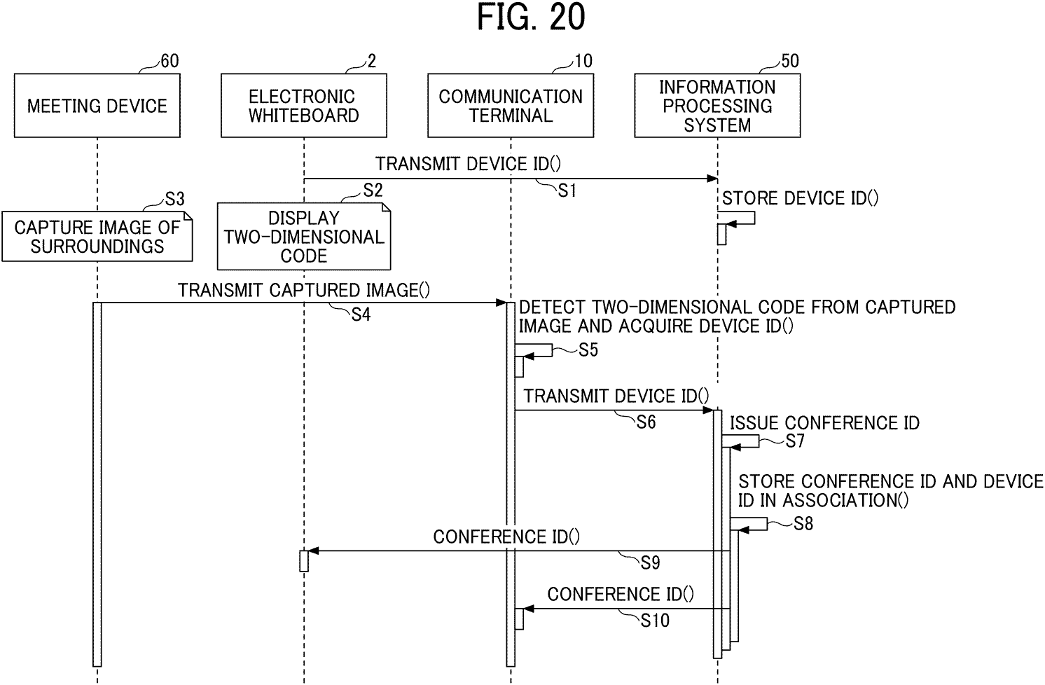

FIG. 19 is an example of a conference list screen 230 displayed by the information recording application 41. The conference list screen 230 presents a list of conferences, specifically, a list of the records (videos) recorded during teleconferences. The list of conferences includes conferences held in a certain conference room as well as teleconferences.

The conference list screen 230 displays conference information for which the logged-in user has a right to view, in the conference information storage area 5001. The information on the video, stored in the information storage area 1001, may be further integrated.

The conference list screen 230 is displayed when the user selects a conference list tab 231 on the initial screen 200 of FIG. 16. The conference list screen 230 displays a list 236 of the videos (records) for which the user has the viewing authority. The conference creator (minutes creator) can set the right to view for a participant of the conference. The list of conferences may be a list of stored records, a list of scheduled conferences, or a list of conference data.

The conference list screen 230 includes items of a check box 232, an update date/time 233, a title 234. and a status 235.

The check box 232 receives selection of a video file. The check box 232 is used when the user desires to collectively delete video files.

The update date/time 233 indicates a recording start time of the combined video. If the combined video is edited, the update date/time 233 may indicate the edited date and time.

The title 234 indicates the title (such as a subject) of the conference. The title may be transcribed from the conference information or set by the user.

The status 235 indicates whether the combined video has been uploaded to the information processing system 50. If the video has not been uploaded, “local PC” is displayed, whereas if the video has been uploaded, “uploaded” is displayed. If the video has not been uploaded, an upload button is displayed. If there is a combined video yet to be uploaded, it is desirable that the information recording application 41 automatically upload the combined video when the user logs into the information processing system 50.

When the user selects a desired title from the list 236 of the combined videos with a pointing device, the information recording application 41 displays a replay screen. The replay screen allows playback of the combined video.

It is desirable that the information recording application 41 provides a function for the user to narrow down conferences based on the update date and time, the title, the keyword, or the like. Further, there may be a where the user has a difficulty finding a conference of interest because many conferences are displayed. For such a case, the information recording application 41 desirably provides a search function for receiving input of a word or phrase to narrow down the video (record) and to present videos having a title or including an utterance that matches the input word or phrase. The search function allows the user to find desired record in a short time even if the number of records increases. The conference list screen 230 may allow the user to sort the conferences by using the update date and time or the title.

### Operation or Processing

FIG. 20 is a sequence diagram illustrating an operation performed by the record creation system 100 to associate the meeting device 60 with the electronic whiteboard 2. In the description of FIG. 20, a user who participates in a conference using the meeting device 60 and the electronic whiteboard 2 in the same conference.

S1: When the electronic whiteboard 2 installed in the conference room in which the conference is to be held is powered on, the electronic whiteboard 2 communicates with the preset information processing system 50. The electronic whiteboard 2 specifies the device ID and registers that the electronic whiteboard 2 can be associated with the conference.

S2: The code generation unit 35 of the electronic whiteboard 2 disposed in the conference room and to be used in the conference generates a two-dimensional code in which the device ID of the electronic whiteboard 2 and information indicating that the device is usable in the conference. The display control unit 34 displays the two-dimensional code. The two-dimensional code may further include a password for the electronic whiteboard 2 to authenticate the other device.

S3: The user carrying the communication terminal 10 and the meeting device 60 enters the conference room where the electronic whiteboard 2 is installed, and connects the communication terminal 10 and the meeting device 60 with a USB cable. The meeting device 60 starts up in response to power supply from the USB cable or power-on. In this way, the meeting device 60 enters a standby state. The user starts the information recording application 41 on the communication terminal 10. The information recording application 41 starts communicating with the meeting device 60, so that the meeting device 60 starts capturing images and collecting sound. The panoramic image generation unit 62 of the meeting device 60 captures an image of the surroundings and generates a panoramic image of the surroundings (image data) including the two-dimensional code.

S4: The terminal communication unit 61 of the meeting device 60 transmits the panoramic image and talker images to the communication terminal 10.

S5: The device communication unit 16 of the communication terminal 10 receives the panoramic image. The code analysis unit 22 detects the two-dimensional code displayed on the electronic whiteboard 2 from the panoramic image. The code analysis unit 22 decodes the two-dimensional code. If the code analysis unit 22 determines that information indicating that the device is usable in the conference is embedded, the code analysis unit 22 acquires the device ID of the electronic whiteboard 2 from the two-dimensional code. The two-dimensional code may be analyzed by the meeting device 60. That is, the meeting device 60 may include a code analysis unit.

S6: The communication unit 11 implemented by the information recording application 41 specifies the device ID of the electronic whiteboard 2 and transmits a registration request for a conference to the information processing system 50. Preferably, the communication unit 11 further transmits identification information of the meeting device 60 to the information processing system 50.

S7: When the communication unit 51 of the information processing system 50 receives a registration request (device ID) for a conference, the communication management unit 54 issues a conference ID. In a case where the information recording application 41 receives the selection of the conference from the conference list screen 230 or the like, the communication unit 51 attaches the conference ID to the device ID. Accordingly, the communication management unit 54 does not issue the conference ID.

S8: Then, the device management unit 55 stores the device ID of the electronic whiteboard 2 and the conference ID in association with each other (and preferably the device ID of the meeting device 60 and the conference ID in association with each other) in the association storage area 5003.

S9, S10: The communication unit 51 of the information processing system 50 transmits the conference ID to the communication terminal 10 and the electronic whiteboard 2. The communication unit 11 of the communication terminal 10 receives and stores the conference ID. Similarly, when the communication unit 36 of the electronic whiteboard 2 receives the conference ID, the communication unit 36 stores the conference ID. The communication terminal 10 receives at least one of the conference ID and the device ID as a response to the registration request for the conference. The electronic whiteboard 2 and the information processing system 50 may communicate with each other by a two-way communication scheme such as WebSocket that enables push communication from the information processing system 50 to the electronic whiteboard 2.

Since the electronic whiteboard 2 and the communication terminal 10 have the same conference ID, the electronic whiteboard 2 and the meeting device 60 are associated with the conference. After that, the communication terminal 10 attaches at least one of the conference ID and the identification information of the meeting device 60 to data to be transmitted, and the electronic whiteboard 2 attaches at least one of the conference ID and the device ID to data to be transmitted. In this manner, the conference ID is attached to the communication in the present embodiment. Alternatively, the device ID or the identification information of the meeting device 60 may be attached to the communication. The information processing system 50 can specify the conference ID from the attached identification information based on the association information.

The associating the electronic whiteboard 2 with the conference ID in FIG. 20 is performed for associating the record with the hand-drafted data or the like input to the electronic whiteboard 2. Further, the electronic whiteboard 2 has a function of sharing objects with another electronic whiteboard 2 located at a remote site. The electronic whiteboard 2 and another electronic whiteboard 2 are registered in a server for teleconference and can share hand-drafted data or the like in real time.

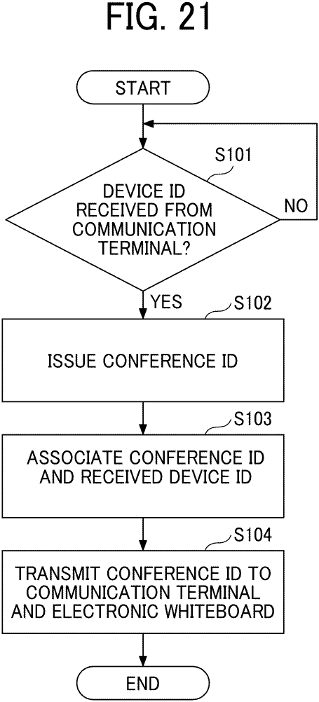

FIG. 21 is a flowchart illustrating the operation of the information processing system 50. The communication unit 51 of the information processing system 50 monitors whether a device ID is received from the communication terminal 10 until a device ID is received (S101).

When the communication unit 51 receives the device ID (Yes in S101), the communication management unit 54 issues a conference ID (S102). When the communication unit 51 receives the conference ID attached to the device ID, the communication management unit 54 does not issue the conference ID.

The device management unit 55 stores the conference ID and the received device ID in association with each other in the association storage area 5003 (S103). The device management unit 55 maintains the association between the conference ID and the device ID until the end of the conference (end of recording).

The communication unit 51 of the information processing system 50 transmits the conference ID to the communication terminal 10 and the electronic whiteboard 2 (S104).

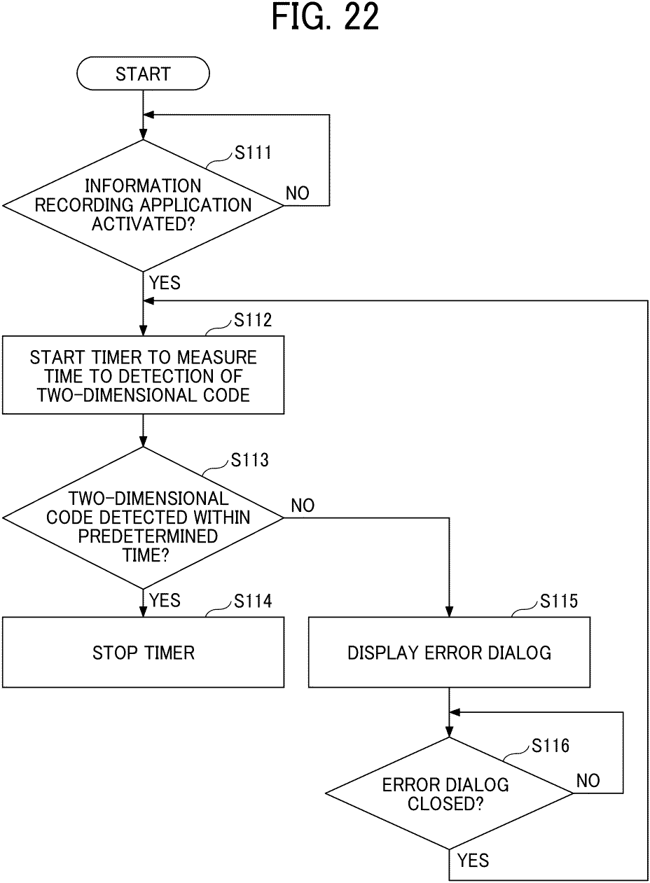

FIG. 22 is a flowchart illustrating the operation of the information recording application 41 operating on the communication terminal 10. This process is performed for a case where there is an obstacle (e.g., a person) in front of the electronic whiteboard 2 to inhibit the information recording application 41 from detecting the two-dimensional code, and accordingly the electronic whiteboard 2 cannot be associated with the conference.

First, the information recording application 41 is activated (S111).

Next, the time measuring unit 25 starts measuring the time from the activation of the information recording application 41 to the detection of the two-dimensional code (S112).

Since the device communication unit 16 receives the panoramic image, the code analysis unit 22 detects the two-dimensional code. The time measuring unit 25 determines whether or not the two-dimensional code is detected within a predetermined time after the activation (S113).

When the two-dimensional code is detected within the predetermined time after the activation (Yes in S113), the time measuring unit 25 stops measuring time (S114).

When the two-dimensional code is not detected within the predetermined time after the activation (No in S113), the display control unit 13 displays an error dialog in response to a notification from the time measuring unit 25 (S115).

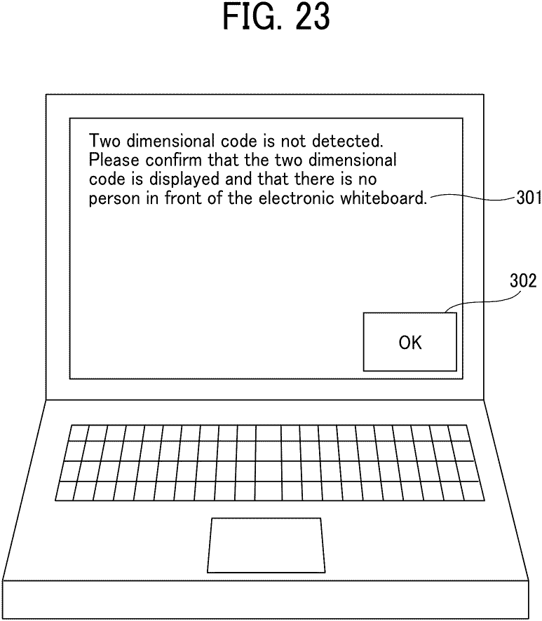

FIG. 23 is an example of a message 301 displayed in the error dialog by the information recording application 41 executing on the communication terminal 10. The message 301 of the error dialog is, for example, “Two-dimensional code is not detected. Please confirm that the two-dimensional code is displayed and that there is no person in front of the electronic whiteboard.” The user can recognize from the message 301 that the two-dimensional code is not detected, and can take measures such as causing a person to move away from the front of the electronic whiteboard 2. An OK button 302 is a button for the information recording application 41 to measure the time again.

Referring back to FIG. 22, when the pressing of the OK button 302 is received in step S115 and the error dialog is closed (Yes in step S116), the process returns to step S112. The time measuring unit 25 starts measuring time.

For the user to close the error dialog, the error dialog may be provided with a cancel button so that the user can start the conference without associating the electronic whiteboard 2 with the conference.

### Two-Dimensional Code and Barcode Displayed by Electronic Whiteboard

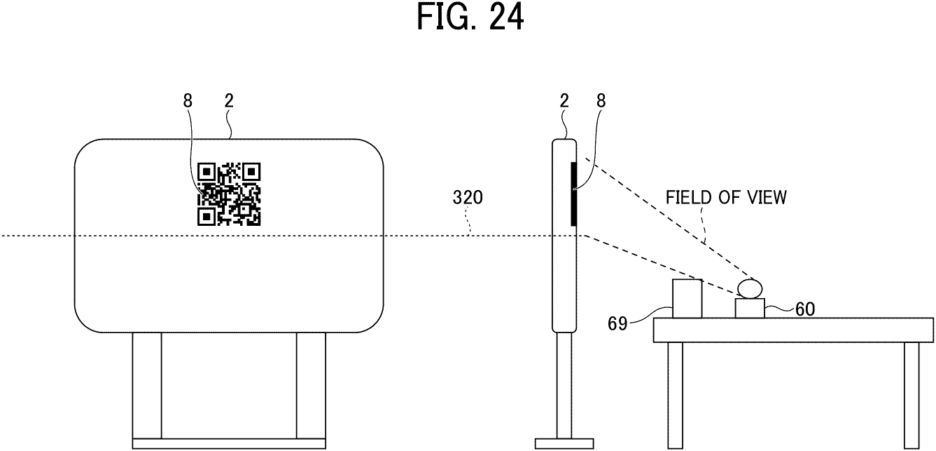

A supplemental description is given of the two-dimensional code and the barcode displayed by the electronic whiteboard 2, with reference to FIGS. 24 to 31. If there is an obstacle 69 between the meeting device 60 and the electronic whiteboard 2, the communication terminal 10 may not be able to acquire the device ID. Therefore, it is effective to adjust the position at which the electronic whiteboard 2 displays the two-dimensional code 8 as described below.

FIG. 24 is a schematic diagram illustrating an example of the position of the two-dimensional code 8 displayed on the electronic whiteboard 2. As described above, the two-dimensional code 8 includes the device ID and the information indicating a device usable in a conference. On the desk where the meeting device 60 is placed, there is the obstacle 69 between the meeting device 60 and the electronic whiteboard 2. Note that the camera included in the meeting device 60 is not necessarily a spherical or hemispherical camera for detecting the two-dimensional code 8. The electronic whiteboard 2 displays the device ID above a center line 320 of the display screen of the electronic whiteboard 2 in the vertical direction. Thus, even if the obstacle 69 is present between the meeting device 60 and the electronic whiteboard 2, the meeting device 60 can easily capture an image of the device ID.

As illustrated in FIG. 25, the electronic whiteboard 2 may display the center of the two-dimensional code 8 above the center line 320 of the screen of the electronic whiteboard 2 in the vertical direction.

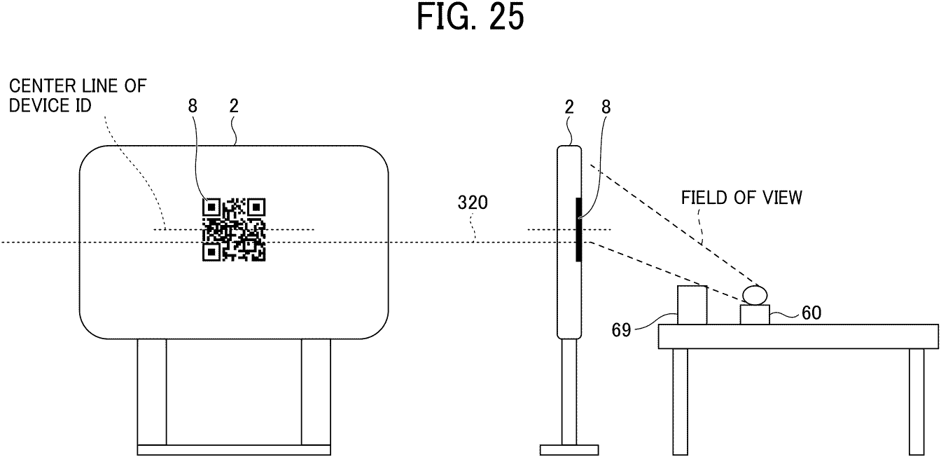

Alternatively, as illustrated in FIG. 26, the electronic whiteboard 2 may move the two-dimensional code 8 according to an elapsed time. In FIG. 26, the two-dimensional code 8 moves from left to right. The electronic whiteboard 2 may move the two-dimensional code 8 being displayed. Alternatively, the electronic whiteboard 2 may display the two-dimensional code 8, stop displaying the two-dimensional code 8, and again display the two-dimensional code 8 at a different position. Thus, even if the position of the obstacle 69 is uncertain, the meeting device 60 can easily capture the device ID. Further, even when the electronic whiteboard 2 displays the two-dimensional code 8 in a small size in order to reduce the feeling of pressure on the user, the meeting device 60 can easily capture the image of the two-dimensional code 8.

Furthermore, the electronic whiteboard 2 may change the size of the two-dimensional code 8 while moving the two-dimensional code 8.

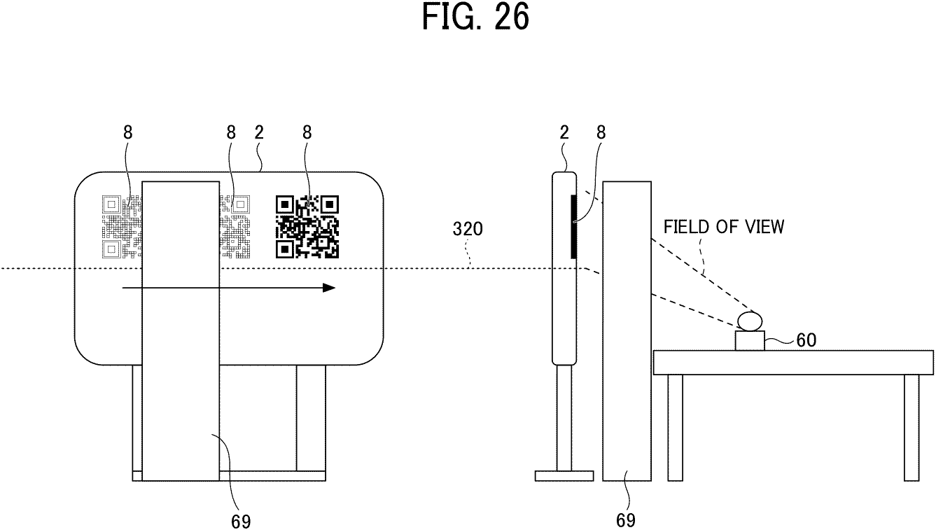

Alternatively, as illustrated in FIG. 27, the electronic whiteboard 2 may simultaneously display a plurality of two-dimensional codes 8. Thus, even if some of the two-dimensional codes 8 are hidden by the obstacle 69. the meeting device 60 can easily capture images of the other two-dimensional codes 8. All of the two-dimensional codes 8 may include the same set of information or different sets of information.

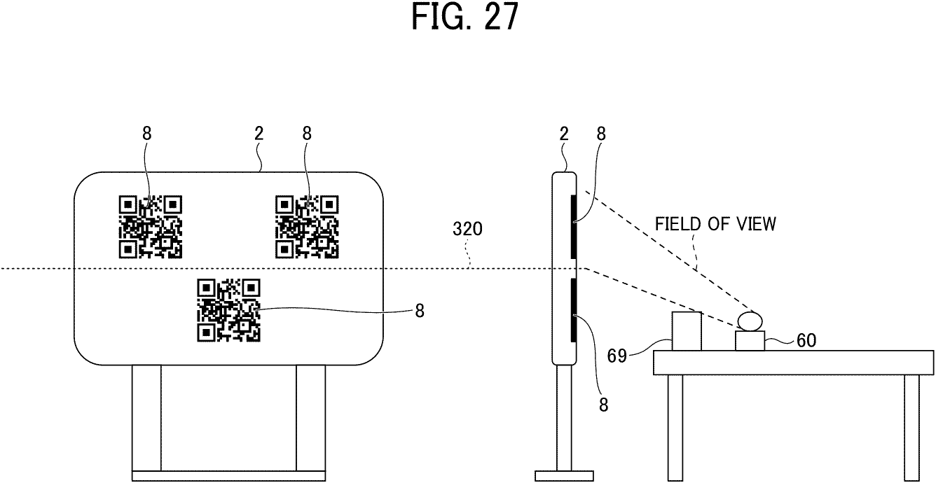

Alternatively, as illustrated in FIG. 28, the electronic whiteboard 2 may display the two-dimensional code 8 at a position adjacent to (close to) a menu 71. The menu 71 extends vertically at the right end. Similar to FIG. 24, the two-dimensional code 8 is displayed above the center line 320 of the screen of the electronic whiteboard 2 in the vertical direction.

The two-dimensional code 8 displayed close to the menu 71 is less likely to cause discomfort for the user. In addition, This allows the user to use a wide area of the screen.

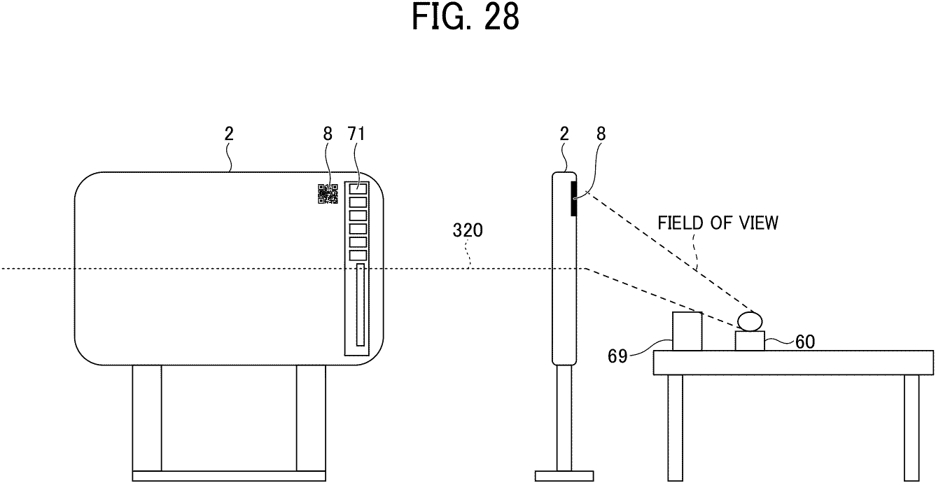

Alternatively, as illustrated in FIG. 29, the electronic whiteboard 2 may display the two-dimensional code 8 in the menu 71. Compared with the example of FIG. 28, this configuration alleviates the discomfort for the user and allows the user to use a wider area of the screen.

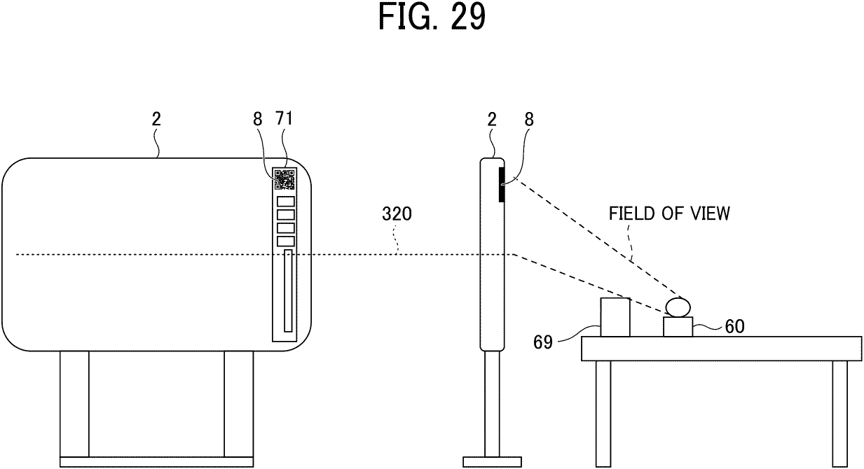

FIG. 30 is a schematic diagram illustrating an example of a method for displaying the two-dimensional code 8 performed by the electronic whiteboard 2 in a case where the meeting device 60 includes a hemispherical camera. By using a hemispherical camera having a wide field of view in the horizontal direction in the configurations illustrated in FIGS. 24 to 29, the two-dimensional code 8 can be found more easily.

Note that a barcode can be displayed in the same manner as the manner of display of the two-dimensional code 8 in FIGS. 24 to 30.

FIG. 31 is a schematic diagram illustrating an example of a method for displaying a barcode 7 by the electronic whiteboard 2.

Note that the barcode 7 is less robust against inclination than the two-dimensional code 8. For this reason, the code analysis unit 22 implemented by the information recording application 41 cuts out a monochrome pattern of the barcode 7 and adjusts a skew angle and a pitch angle of the monochrome pattern. The code analysis unit 22 performs edge enhancement on black bars. The code analysis unit 22 performs pattern matching of the cut out image with a pattern (from a start character to a stop character at the right end) registered as a pattern of the barcode 7, so as to detect the barcode 7 on the electronic whiteboard 2.

The examples in which the two-dimensional code 8 or the barcode 7 is displayed have been described with reference to FIGS. 24 to 31. Alternatively, the information recording application 41 may detect, by using optical character recognition (OCR), a device ID (alphabets or numbers) displayed by the electronic whiteboard 2.

### Storage of Combined Video

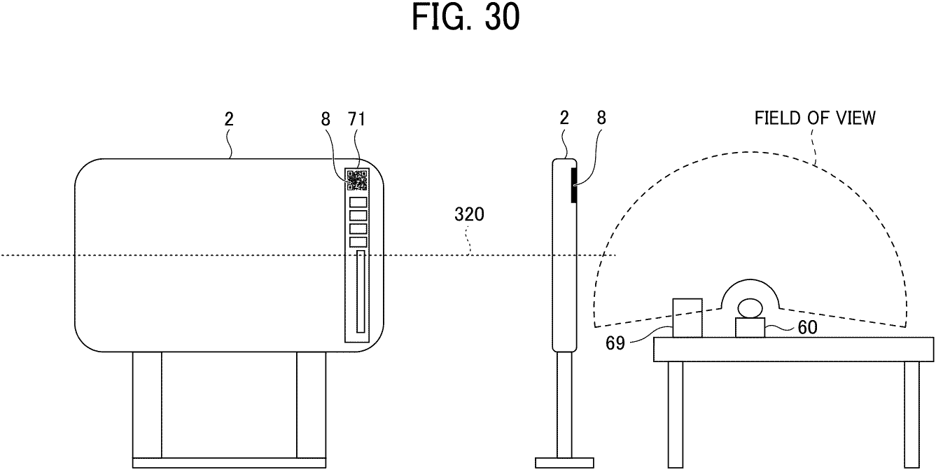

A process of storing a combined video will be described with reference to FIG. 32. FIG. 32 is a sequence chart illustrating an example of recording a panoramic image, a talker image, and an application screen by the information recording application 41. Since the conference ID is transmitted from the information processing system 50 to the communication terminal 10 and the electronic whiteboard 2 in S9 and S10 of FIG. 20, the information recording application 41 can record the video.

S21: The user operates the teleconference application 42 to start a teleconference. In this example, the teleconference application 42 at the first site 102 and the teleconference application 42 at the second site 101 start a teleconference. The teleconference application 42 operating on the communication terminal 10 at the first site 102 transmits an image captured by the camera of the meeting device 60 and audio collected by the microphone of the meeting device 60 to the teleconference application 42 operating on the communication terminal 10 at the second site 101 The teleconference application 42 on the communication terminal 10 at the second site 101 displays the received image on the display of the communication terminal 10 and outputs the received audio from the speaker of the communication terminal 10. Similarly, the teleconference application 42 on the communication terminal 10 at the second site 101 transmits an image captured by a camera of another meeting device 60 at the second site 101 and audio collected by a microphone of the meeting device 60 at the second site 101 to the teleconference application 42 on the communication terminal 10 at the first site 102. The teleconference application 42 on the communication terminal 10 at the first site 102 displays the received image on the display and outputs the received audio from the speaker. The teleconference application 42 at the first site 102 and the teleconference application 42 at the second site 101 repeat this processing to implement the teleconference.

S22: The user inputs settings relating to recording on the recording setting screen 210 illustrated in FIG. 17, provided by the information recording application 41. The operation reception unit 12 implemented by the information recording application 41 receives the settings. In this example, both the camera toggle button 211 and the PC screen toggle button 212 are on.

In a case that the user has reserved a teleconference in advance, a list of teleconferences is displayed in response to pressing of the button 221 labeled as “get information from calendar” illustrated in FIG. 18 by the user. The user selects a desired teleconference to be associated with the video to be recorded. Since the user has logged into the information processing system 50, the information processing system 50 identifies teleconferences for which the logged-in user has a right to view. The information processing system 50 transmits the list of the identified teleconferences to the communication terminal 10. Thus, the user selects a teleconference that is being held or to be held. In this way, information related to the teleconference such as the conference ID is determined. In the present embodiment, the conference ID has already been generated in the processing illustrated in FIG. 20.

S23: The user instructs the information recording application 41 to start recording. For example, the user presses the button 216 labelled as “start recording now.” The operation reception unit 12 implemented by the information recording application 41 receives the instruction. The display control unit 13 displays the recording-in-progress screen 220.

S24: Since the conference ID is determined, the communication unit 11 implemented by the information recording application 41 specifies the conference ID and requests the information processing system 50 to transmit information on the storage location.

S25: The communication unit 51 of the information processing system 50 receives the request. The communication management unit 54 transmits information on the storage location (URL of the storage service system 70) of the combined video (video file) to the information recording application 41 via the communication unit 51.

S26: When the communication unit 11 implemented by the information recording application 41 receives the conference ID and the storage location of the video file, the recording control unit 17 determines that preparation for recording is completed and starts recording.

S27: The app screen acquisition unit 14 implemented by the information recording application 41 request an application selected by the user to send a screen thereof. More specifically, the app screen acquisition unit 14 acquires the screen of the application via the OS. The description given with reference to FIG. 32 is on the assumption that the user selects the teleconference application 42.

S28: The recording control unit 17 implemented by the information recording application 41 notifies the meeting device 60 of the start of recording via the device communication unit 16. With the notification, the recording control unit 17 preferably sends information indicating that the camera toggle button 211 is on (a request for a panoramic image and a talker image). The meeting device 60 transmits the panoramic image and the talker image to the information recording application 41 regardless of the presence or absence of the request.

S29: In response to receiving the notification of the start of recording by the terminal communication unit 61 of the meeting device 60, a unique recording ID is assigned. The terminal communication unit 61 transmits the recording ID to the information recording application 41. In one example, the information recording application 41 assigns the recording ID. In another example, the recording ID is acquired from the information processing system 50.

S30: The audio reception unit 15 implemented by the information recording application 41 acquires audio data output by the communication terminal 10 (audio data received by the teleconference application 42).

S31: The device communication unit 16 transmits the audio data acquired by the audio reception unit 15 and a combining request of audio to the meeting device 60.

S32: In response to receiving the audio data and the combining request by the terminal communication unit 61 of the meeting device 60, the audio synthesis unit 65 combines (or synthesizes) the received audio data with the audio of the surroundings collected by the sound collection unit 64. For example, the audio synthesis unit 65 adds the two audio data items together. Since clear sound around the meeting device 60 is recorded, particularly the accuracy of text converted from the sound around the meeting device 60 (in the conference room) increases.

The communication terminal 10 may perform this combination of the audio data. Alternatively, the recording function may be allocated to the meeting device 60, and the audio processing may be allocated to the communication terminal 10. In this case, the load on the meeting device 60 is reduced.

S33: Further, the panoramic image generation unit 62 of the meeting device 60 generates a panoramic image, and the talker image generation unit 63 generates a talker image.

S34: The device communication unit 16 of the information recording application 41 repeatedly receives the panoramic image (surrounding image data) and the talker image from the meeting device 60. Further, the device communication unit 16 repeatedly receives the combined audio data from the meeting device 60. The device communication unit 16 may send a request to the meeting device 60 to acquire such images and data. Alternatively, the meeting device 60 that has received information that the camera toggle button 211 is on may automatically transmit the panoramic image and the talker image. In response to receiving the combining request of audio, the meeting device 60 may automatically transmit the combined audio data to the information recording application 41.

S35: The recording control unit 17 implemented by the information recording application 41 arranges the application screen acquired from the teleconference application 42, the panoramic image 203. and the talker images 204 adjacent with one another, to create a combined image. The recording control unit 17 repeatedly creates the combined image and designates each combined image as a frame of a video, to create a combined video. The recording control unit 17 stores the audio data received from the meeting device 60.

S36: The communication unit 36 of the electronic whiteboard 2 transmits the object information (information on, for example, hand-drafted data) to the information processing system 50 in association with the conference ID, preferably for each stroke.

The information recording application 41 repeats steps S30 to S36 described above.

The processing of steps S30 to S36 is not necessarily performed in the order presented in FIG. 32. For example, the combining the audio data and the creating the combined image may be performed in opposite order.

As described above, in the record creation system 100 according to the present embodiment, the meeting device 60 acquires the device ID of the device used in the conference room, and the communication terminal 10 transmits the device ID to the information processing system 50. Then, the information processing system 50 associates the conference with the device used in the conference. Since the meeting device 60 is connected to the communication terminal 10 that communicates with the information processing system 50, the meeting device 60 is also associated with the conference. This configuration obviates the trouble of the user of capturing the two-dimensional code displayed by the device with the camera or registering the device and the meeting device 60 in the information processing system 50 for a conference. With this configuration, a plurality of devices (the meeting device 60 and the electronic whiteboard 2) can be associated with the conference with minimum user intervention.

### Embodiment 2

In the present embodiment, the electronic whiteboard 2 that outputs the device ID by sound and the processing thereof will be described.

Note that the present embodiment is described on an assumption that the hardware configurations of FIGS. 4, 5, and 8 described in the above embodiment are applicable.

### Functions

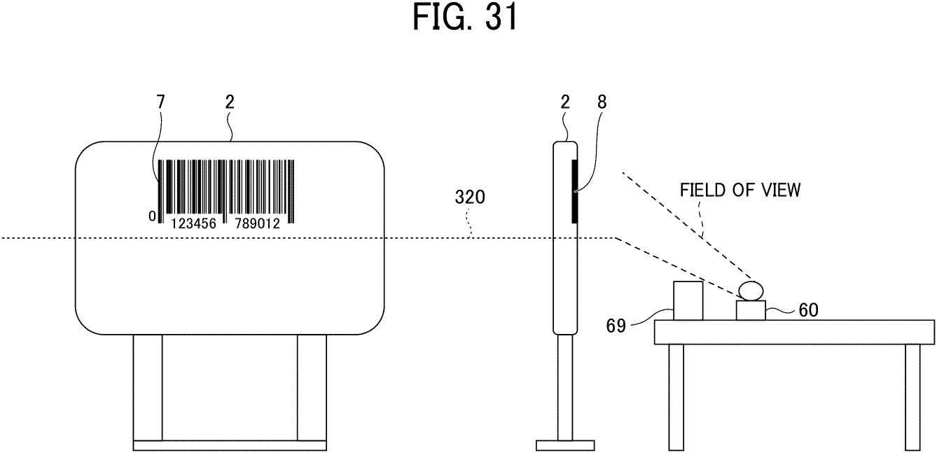

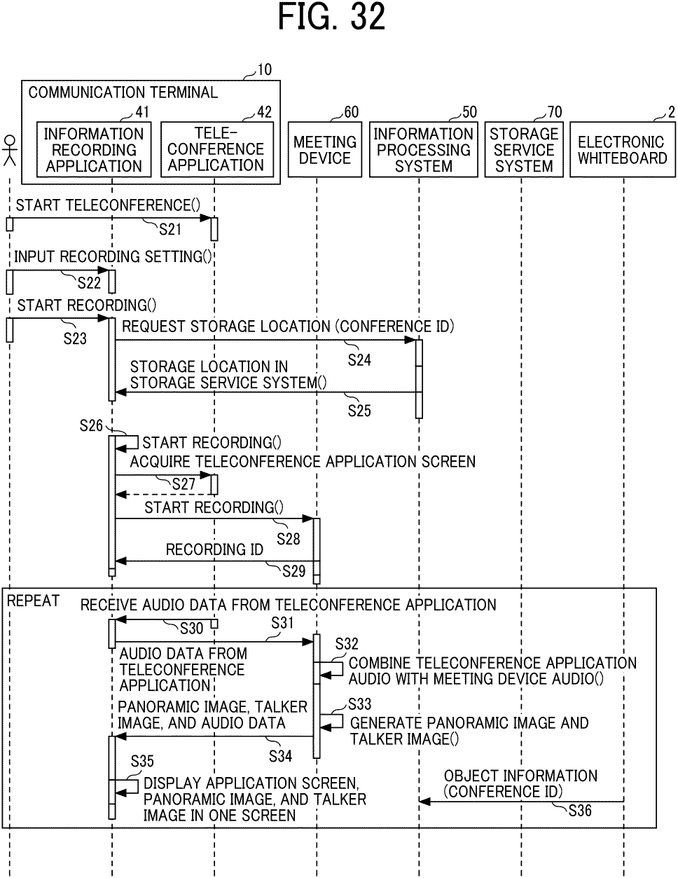

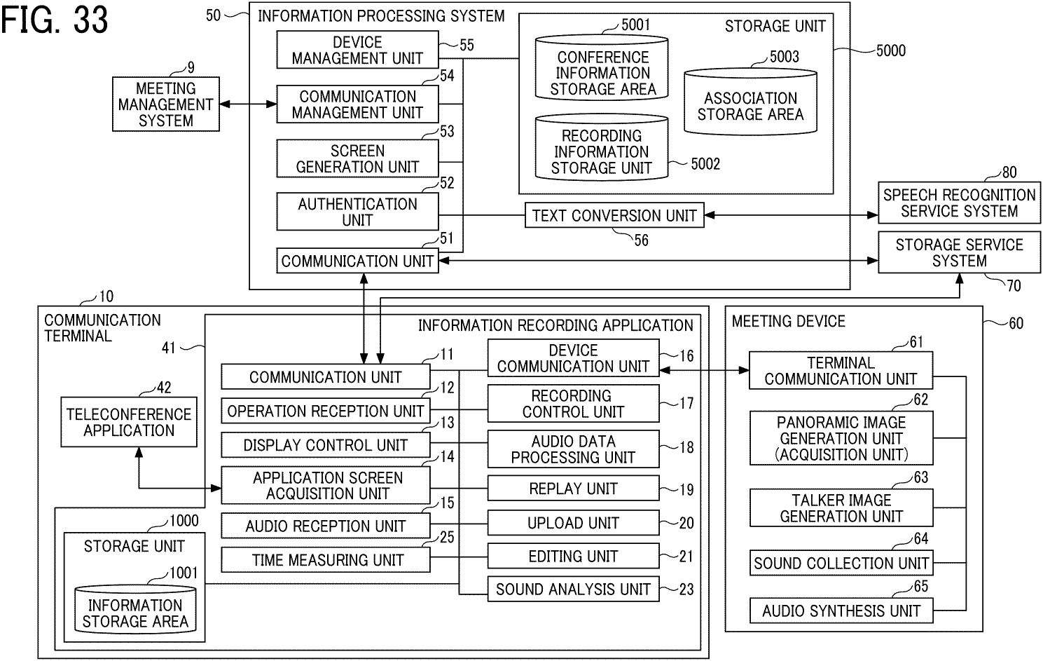

FIG. 33 is a block diagram illustrating functional configurations of the communication terminal 10, the meeting device 60, and the information processing system 50 of the record creation system 100 according to the present embodiment. In the following description with reference to FIG. 33, the differences from FIG. 9 are mainly described.

In FIG. 33, the communication terminal 10 includes a sound analysis unit 23 instead of the code analysis unit 22. As will be described later, the sound analysis unit 23 performs spectrum analysis on sound data to detect a frequency included in the sound data, and converts a specific frequency into bit data, to acquire the device ID.

FIG. 34 is a block diagram illustrating the functional configuration of the electronic whiteboard 2 according to the present embodiment. In the following description with reference to FIG. 34, differences from FIG. 13 are mainly described. The electronic whiteboard 2 illustrated in FIG. 34 includes a sound data generation unit 37. The sound data generation unit 37 converts each of alphabets and numerals in the device ID into a frequency of time T, and generates a sound signal by sampling at a constant interval similar to pulse code modulation (PCM) conversion. The sound signal is converted into an analog signal by an analog-to-digital (A/D) converter included in the speaker 450 (see FIG. 8) and output from the speaker 450. The sound data generation unit 37 serves as an output unit that outputs a sound signal.

In the present embodiment, the sound collection unit 64 of the meeting device 60 serves as an acquisition unit that acquires the sound data.

### Generation of Sound Data

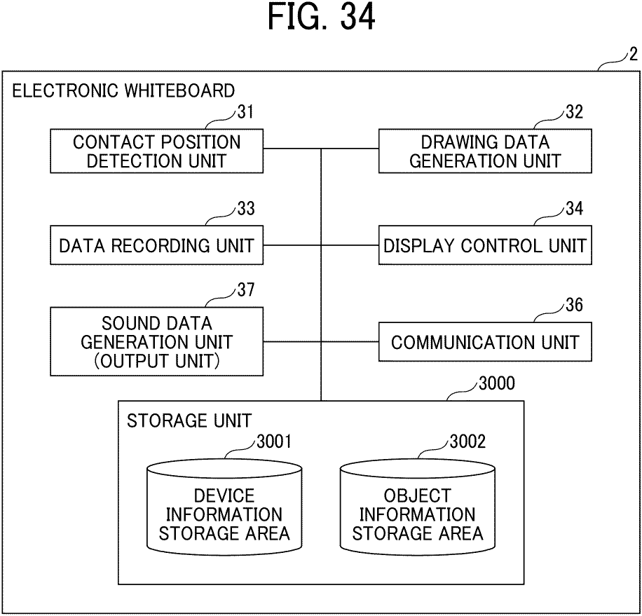

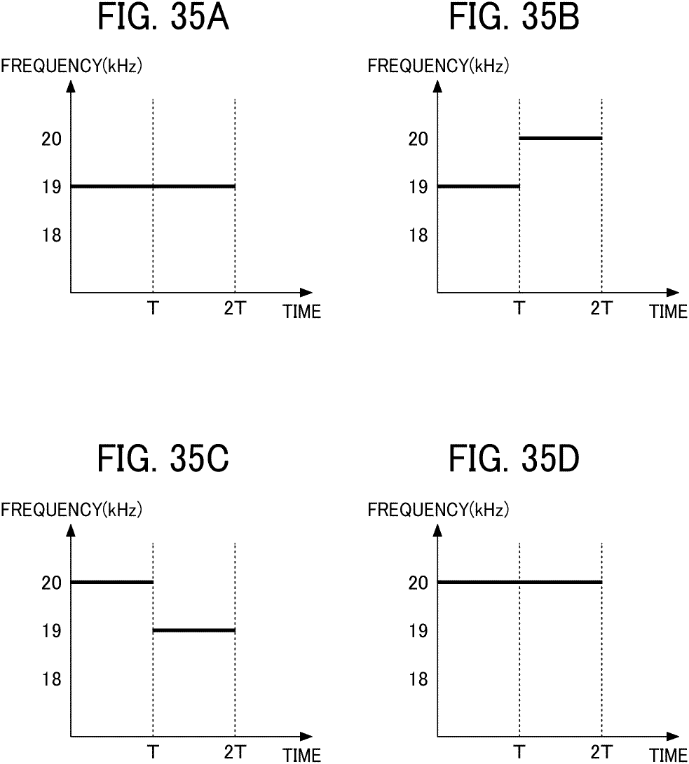

FIGS. 35A to 35C are diagrams illustrating examples of a frequency of sound and a bit pattern used for transmission of the device ID. In FIG. FIGS. 35A to 35C,the frequencies of sound used for transmitting the device ID are 18 kHz, 19 kHz, and 20 kHz. The frequency of 18 kHz is used for a pilot signal to be added before the message. The length of the time T corresponds to one bit. The frequency of 19 kHz corresponds to 0, and the frequency of 20 kHz corresponds to 1. Therefore, FIG. 35A illustrates a value of 00, FIG. 35B illustrates a value of 01, FIG. 35C illustrates a value of 10, and FIG. 35D illustrates a value of 11.

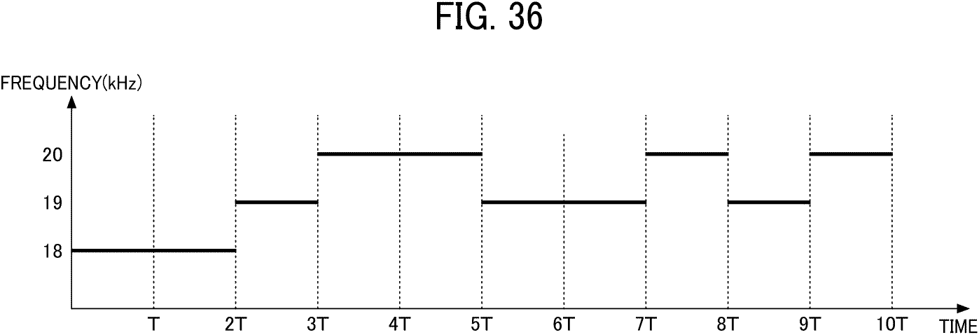

The pilot signal is transmitted by adding 2 bits to every 8 bits of data. When the sound signal represents one alphabet or one numeral by 8 bits, 10 bits are used to transmit one character of the device ID. When the electronic whiteboard 2 transmits, for example, an 8-bit American Standard Code for Information Interchange (ASCII) character “e” (01100101 in binary, 0×65 in hexadecimal), the frequency pattern of the sound signal is as illustrated in FIG. 36.

Numerals 0 to 9 and English capital letters A to Z are used for the device ID of the electronic whiteboard 2. Therefore, the device ID is represented by 8-bit ASCII codes. One character of the device ID has the frequency pattern as illustrated in FIG. 36 together with the pilot signal. In the electronic whiteboard 2, frequency patterns corresponding to the numerals 0 to 9 and the characters A to Z and sound signals based on the time T for one bit are encoded by PCM and stored in advance. For each character of the device ID of the electronic whiteboard 2, the sound data generation unit 37 converts the PCM-encoded sound data into digital sound data using a sound source.

Since the sound collection unit 64 of the meeting device 60 collects the ambient sound and converts the collected ambient sound into sound data (sound signals), the sound collection unit 64 also collects the sound signal generated by the sound data generation unit 37. The sound analysis unit 23 of the communication terminal 10 performs spectrum analysis (Fourier transformation) on the sound signal at regular time intervals (for example, several tens of milliseconds), to obtain a spectrum having a peak at 18 kHz, 19 kHz, or 20 kHz. The sound analysis unit 23 detects the head of a character string used as the device ID with the frequency of 18 kHz and converts the frequency of 19 kHz or the 20 kHz into the value of 0 or 1. As a supplementary explanation, the time (for example, several tens of milliseconds) for the spectrum analysis is shorter than the time T. Accordingly, the sound analysis unit 23 combines, for each time T, the sound data into one bit of 0 or 1 depending on which of 0 and 1 is greater, and reproduces the device ID. The time (for example, several tens of milliseconds) for the spectrum analysis may be the same as the time T.

A description is given below of a sequence of operations.

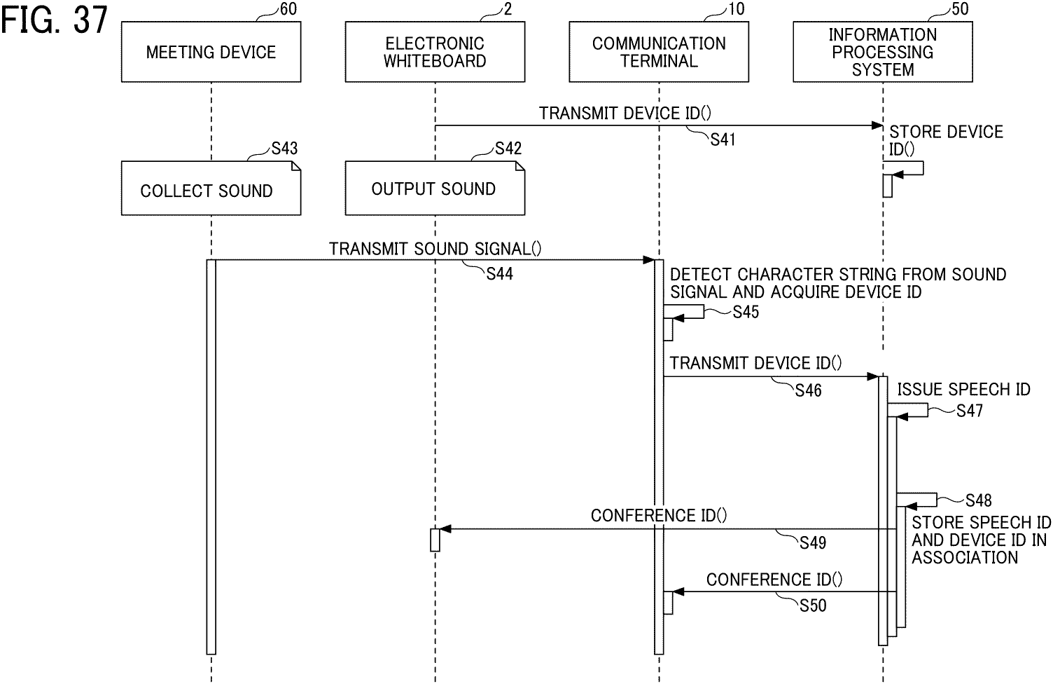

FIG. 37 is a sequence diagram illustrating an operation performed by the record creation system 100. In the following description with reference to FIG. 37, differences from FIG. 20 are mainly described. Step S41 is similar to Step S1 in FIG. 20.

S42: The user presses a button on the electronic whiteboard 2 placed in the conference room used in the conference for outputting the device ID of the electronic whiteboard 2. The sound data generation unit 37 of the electronic whiteboard 2 generates a sound signal representing, by frequency, the device ID of the electronic whiteboard 2 and outputs the sound signal from the speaker 450 (see FIG. 8). The sound signal may be automatically output at power-on.

S43: The sound collection unit 64 of the meeting device 60 collects the sound signal output by the electronic whiteboard 2 with a microphone and performs PCM encoding on the sound signal.

S44: The terminal communication unit 61 of the meeting device 60 transmits the sound signal to the communication terminal 10.

S45: The device communication unit 16 of the communication terminal 10 receives the sound signal. The sound analysis unit 23 performs frequency analysis on the sound signal, to divide the sound signal for each pilot signal of 18 kHz, and converts the frequencies (19 kHz, 20 kHz) included in each divided piece of the sound signal into an 8-bit string based on the conversion rule of FIGS. 35A to 35D. The sound analysis unit 23 converts the sound data into the device ID by using a conversion table of 8-bit ASCII codes. In the conversion table, numerals 0 to 9 and English capital letters A to Z (8-bit strings) are associated with the frequency patterns illustrated in FIGS. 36A to 36D.

S46: The communication unit 11 of the communication terminal 10 transmits the device ID to the information processing system 50. Subsequent processing may be similar to the processing in FIG. 20.

Although the meeting device 60 collects the sound signal in FIG. 37, the communication terminal 10 may directly collect the sound signal.

In addition, although the frequencies of the sound are set to 18 kHz to 20 kHz in the above-described embodiment, these frequencies are in an audible range, and there is a concern that the user may hear the sound. Thus, for example, the electronic whiteboard 2 may output the device ID as a sound with ultrasonic waves of about 50 to 100 kHz.

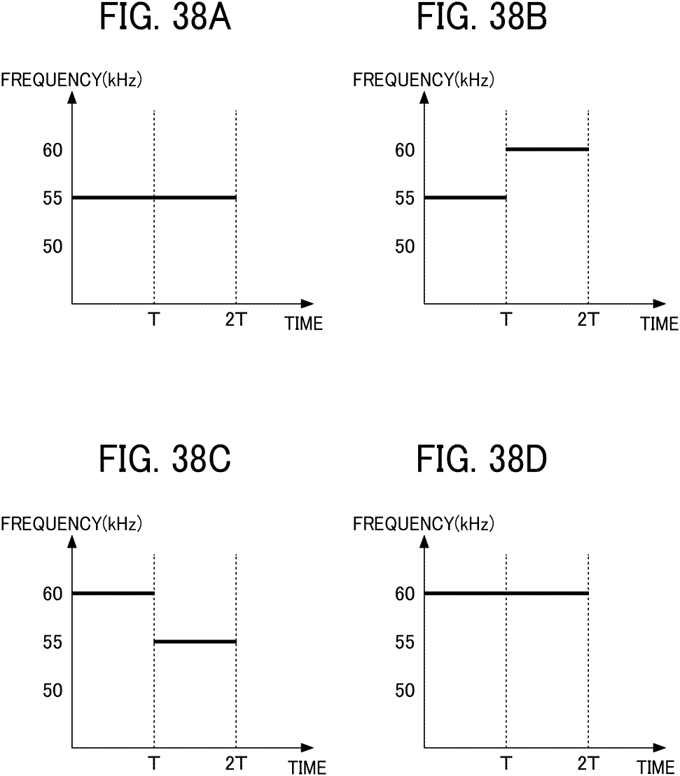

FIGS. 38A to 38D illustrates examples of correspondence between frequencies and bit data in the case of ultrasonic waves. In FIGS. 38A to 38D,ultrasonic waves having frequencies of 50 kHz (used as a pilot signal), 55 kHz, and 60 kHz are illustrated, but the ultrasonic waves may have other frequencies. FIG. 38A illustrates a value of 00, FIG. 38B illustrates a value of 01, FIG. 38C illustrates a value of 10, and FIG. 38D illustrates a value of 11.

In this case, it is preferable that the speaker 450 of the electronic whiteboard 2 also supports ultrasonic waves and that the microphones 608 of the meeting device 60 supports ultrasonic waves.

According to the present embodiment, the electronic whiteboard 2 can notify the meeting device 60 of the device ID by sound. Accordingly, the present embodiment provides, in addition to the effects of Embodiment 1, an effect of making it easier for the meeting device 60 to acquire the device ID even if a person is present in front of the electronic whiteboard 2.

### Embodiment 3

In the present embodiment, processing at the end of recording (end of conference) will be described. When the user ends the recording, the information processing system 50 deletes the association between the conference ID and the device ID (releases the electronic whiteboard 2). Further, the electronic whiteboard 2 displays the end of the recording and resumes displaying or outputting the device ID.

The hardware configuration illustrated in FIGS. 4, 5, and 8 and the functional configuration illustrated in FIG. 9 of the above-described embodiment are applicable to the present embodiment.

### Operation or Processing

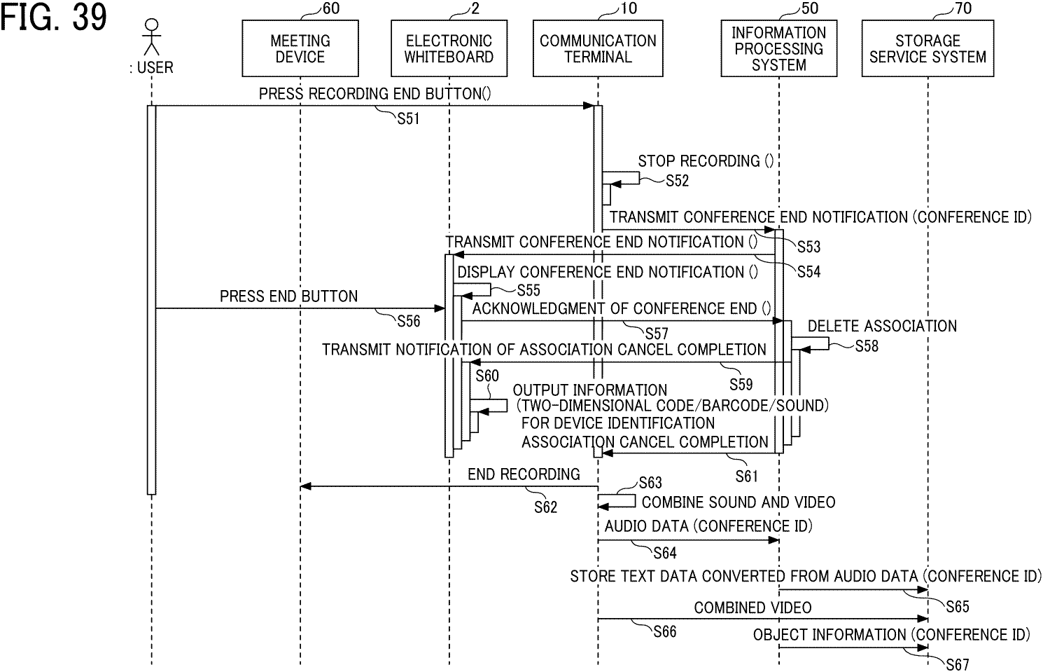

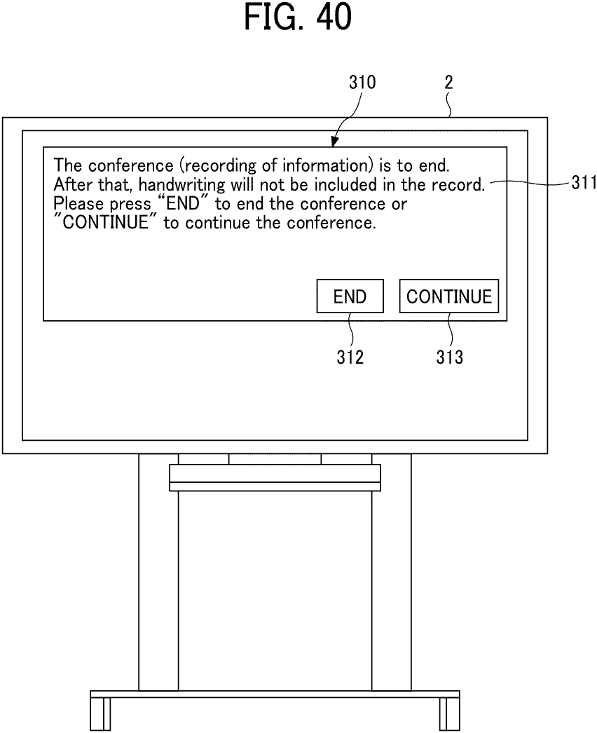

FIG. 39 is a sequence diagram illustrating processing performed by the record creation system 100 when ending the recording of a conference.

S51: ThXe user is about to end the conference in which the meeting device 60 and the electronic whiteboard 2 are used. The user presses the stop recording button 227 on the information recording application 41. The operation reception unit 12 receives the pressing operation.

S52: The recording control unit 17 implemented by the information recording application 41 stops recording the video (stops creating the combined video) and stops recording the audio.

S53: The communication unit 11 implemented by the information recording application 41 transmits a notification of the end of the conference (conference end notification) to the information processing system 50 with designation of the conference ID.

S54: The communication unit 51 of the information processing system 50 receives the conference end notification. The communication management unit 54 transmits the conference end notification to the electronic whiteboard 2 that communicates with the information processing system 50 with the designation of the conference ID of the conference to be ended.

S55: The communication unit 36 of the electronic whiteboard 2 receives the conference end notification, and the display control unit 34 displays a conference end notification screen.

FIG. 40 illustrates an example of a conference end notification screen 310 displayed by the electronic whiteboard 2. The conference end notification screen 310 includes a message 311, an end button 312 (an example of a display component), and a continue button 313. The message 311 is for example, “The conference (recording of information) is to end. After that, handwriting will not be included in the record. Please press “END” to end the conference or “CONTINUE” to continue the conference.” In response to receiving the user’s pressing the end button 312 (an instruction of ending the recording), the electronic whiteboard 2 ends the recording of the object displayed thereon (the object information is not transmitted to the information processing system 50). In response to receiving the user’s pressing the continue button 313, the electronic whiteboard 2 records (transmit, to the information processing system 50,) the object added by the user to the electronic whiteboard 2.

S56: When the user presses the end button 312 on the conference end notification screen 310 displayed by the electronic whiteboard 2, the contact position detection unit 31 receives the pressing.

S57: The communication unit 36 of the electronic whiteboard 2 designates the conference ID and transmits an acknowledgment of conference end to the information processing system 50. The communication unit 36 ends the transmission of the object information to the information processing system 50.

S58: When the communication unit 51 of the information processing system 50 receives the acknowledgment of conference end, the device management unit 55 deletes the association (association information) between the conference ID and the device ID.

S59: The communication unit 51 of the information processing system 50 transmits a notification of association cancel completion to the electronic whiteboard 2.

S60: The communication unit 36 of the electronic whiteboard 2 receives the notification of association cancel completion. Then, the electronic whiteboard 2 resumes the output of the two-dimensional code or the barcode in the case of Embodiment 1, or the sound signal in the case of Embodiment 2. The data recording unit 33 deletes the conference ID.

S61: The communication unit 51 of the information processing system 50 transmits the notification of association cancel completion to the communication terminal 10. The communication unit 11 implemented by the information recording application 41 receives the notification of association cancel completion and deletes the conference ID.

S62: In response to receiving the notification of association cancel completion, the device communication unit 16 implemented by the information recording application 41 transmits a recording end notification to the meeting device 60. The meeting device 60 continues creating the panoramic image and the talker image and combining the audio. The meeting device 60 may change the processing, for example, changing the resolution or frame rate depending on whether or not recording is being performed. The meeting device 60 may interrupt the creation of the panoramic image and the talker image or the combining of the audio in a case where the information recording application 41 is not operated for a predetermined period, for example.

S63: The recording control unit 17 implemented by the information recording application 41 combines the audio data with the combined video, to create the combined video with sound.

S64: In a case that the user puts a mark in the check box 215 labelled as “automatically transcribe after uploading the record” on the recording setting screen 210. the audio data processing unit 18 requests the information processing system 50 to convert the audio data into text data.

Specifically, the audio data processing unit 18 designates the URL of the storage location, and transmits, via the communication unit 11, a request to convert the audio data of the combined video along with the conference ID and the recording ID to the information processing system 50.

S65: The communication unit 51 of the information processing system 50 receives the request to convert the audio data. The text conversion unit 56 converts the audio data into text data using the speech recognition service system 80. The communication unit 51 stores the text data in the same storage location as the storage location of the combined video. In the record information storage area 5002, the text data is association with the combined video by the conference ID and the recording ID. In another example, the communication terminal 10 requests the speech recognition service system 80 to perform speech recognition and stores text data received from the speech recognition service system 80 in the storage location.

S66: The upload unit 20 implemented by the information recording application 41 stores the combined video in the storage location of the combined video via the communication unit 11. In the record information storage area 5002, the combined video is associated with the conference ID and the recording ID. For the combined video, “Uploaded” is recorded.

S67: The communication unit 51 of the information processing system 50 associates the object information transmitted from the electronic whiteboard 2 during the conference with the conference ID, and stores the object information in the same storage location as the storage location of the combined video. Therefore, the object information, the combined video, and the text data are associated with each other by the conference ID.

Since the user is notified of the storage location, the user can share the combined video with other participants by sending the storage location via e-mail or the like. Even when the combined video, the audio data, the text data, and the object information are generated by different devices or apparatuses, the video and data are collectively stored in one storage location. Thus, the user can view the data later in a simple manner.

According to the present embodiment, when the user ends the recording (ends the conference), the information processing system 50 deletes the association between the conference ID and the device ID (releases the electronic whiteboard 2). Further, the electronic whiteboard 2 displays the end of the recording and resumes displaying or outputting the device ID.

### Embodiment 4

In the present embodiment, processing at the end of recording will be described similar to Embodiment 3, but a different ending method will be described.

Note that the present embodiment is described on an assumption that the hardware configurations of FIGS. 4, 5, and 8 described in the above embodiment are applicable.

### Functions

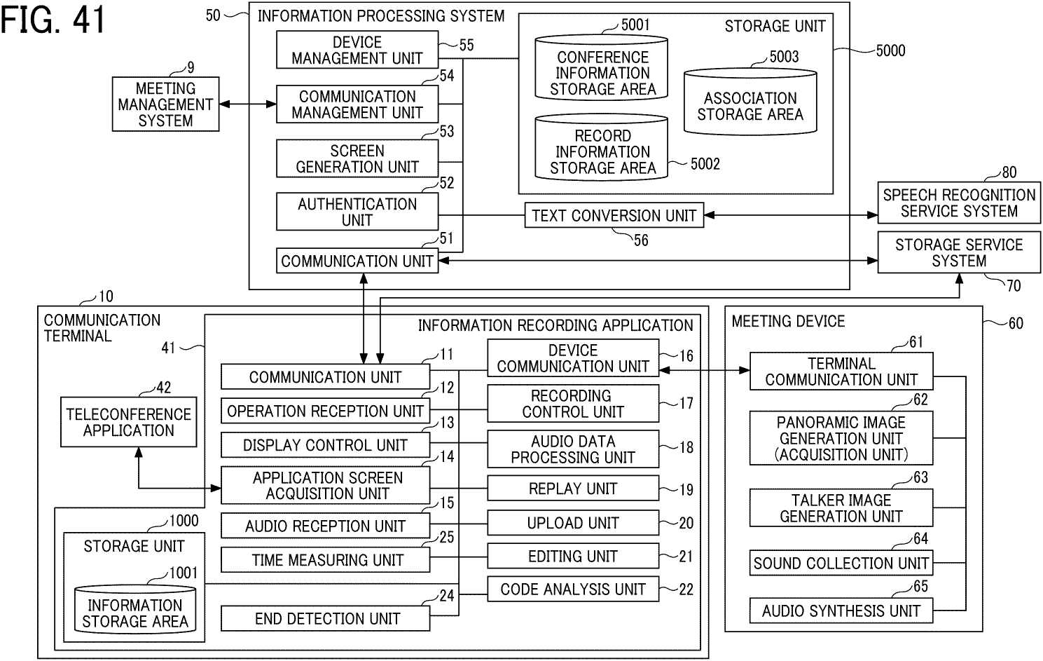

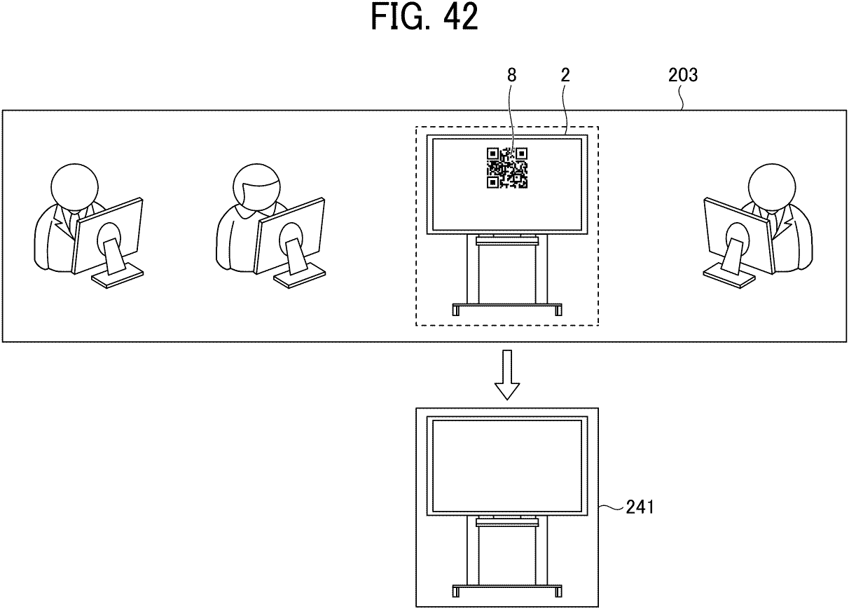

FIG. 41 is an example of a functional block diagram illustrating, as individual blocks, functions of the communication terminal 10, the meeting device 60, and the information processing system 50 of the record creation system 100. In the following description with reference to FIG. 41, the differences from FIG. 9 are mainly described.

In FIG. 41, the communication terminal 10 includes an end detection unit 24. The end detection unit 24 stores the shape of the electronic whiteboard 2 and determines whether the electronic whiteboard 2 is detected in the panoramic image. First, when a two-dimensional code or a barcode is detected, the end detection unit 24 detects the shape (circumscribed rectangle) of the electronic whiteboard 2 in the conference room using pattern matching or machine learning and stores the detected shape.

FIG. 42 illustrates an image 241 representing the shape of the electronic whiteboard 2 detected from the panoramic image. During the recording, the end detection unit 24 repeatedly detects the electronic whiteboard 2 from the panoramic image using the image 241 in FIG. 42 stored as a reference pattern. The end detection unit 24 determines that the conference (recording) has ended based on a determination of absence of the electronic whiteboard 2 in the panoramic image (surrounding image data).

According to such processing, the user can end the conference without pressing the stop recording button 227. The user can end the conference with a gesture of blocking the electronic whiteboard 2 from the meeting device 60 with his/her hand (or by operating a mute button). Alternatively, the user can end the conference by leaving the conference room with the communication terminal 10 and the meeting device 60 connected to each other.

In addition, the end detection unit 24 may detect pulling out of a USB cable (wired cable) from the communication terminal 10. to detect the end of the conference. The device communication unit 16 detects that the USB cable has been pulled out, for example, when the external device I/F 508 detects no voltage and notifies the end detection unit 24 of the detection. In another example, the device communication unit 16 detects communication interruption, for example, on the basis of no response from the meeting device 60. Also in this case, the user can end the conference by pulling out the cable, which is normally performed, without pressing the stop recording button 227.

### Operation or Processing

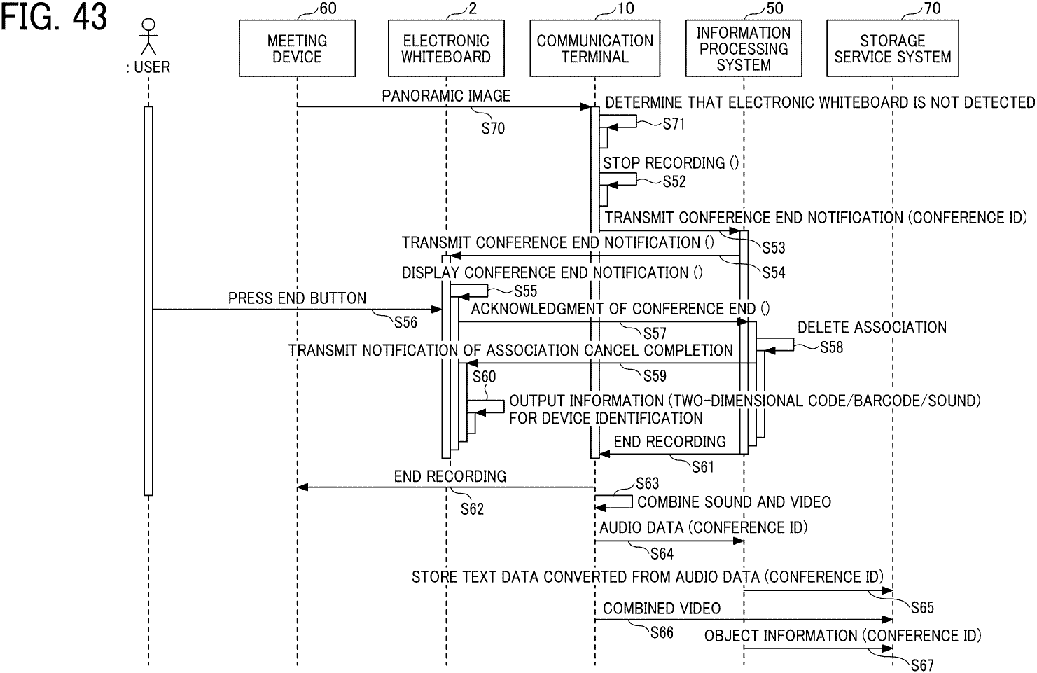

FIG. 43 is a sequence diagram illustrating processing performed by the record creation system 100 when ending the recording of a conference. In the following description with reference to FIG. 43, the differences from FIG. 39 are mainly described.

S70: The terminal communication unit 61 of the meeting device 60 transmits the panoramic image to the communication terminal 10.

S71: The end detection unit 24 detects that the electronic whiteboard 2 is not detected from the panoramic image as described above or detects that the USB cable is unplugged. Note that the meeting device 60 can also detect that the electronic whiteboard 2 is not detected from the panoramic image.

Subsequent processing may be similar to the processing in FIG. 39.

According to the present embodiment, in addition to the effect of Embodiment 3, it is possible to reduce the number of operation steps of the user for ending the conference (recording).

### Embodiment 5

In the present embodiment, processing at the end of recording will be described similar to Embodiment 3, but a different ending method will be described.

Note that the present embodiment is described on an assumption that the hardware configurations of FIGS. 4, 5, and 8 described in the above embodiment are applicable.

### Functions

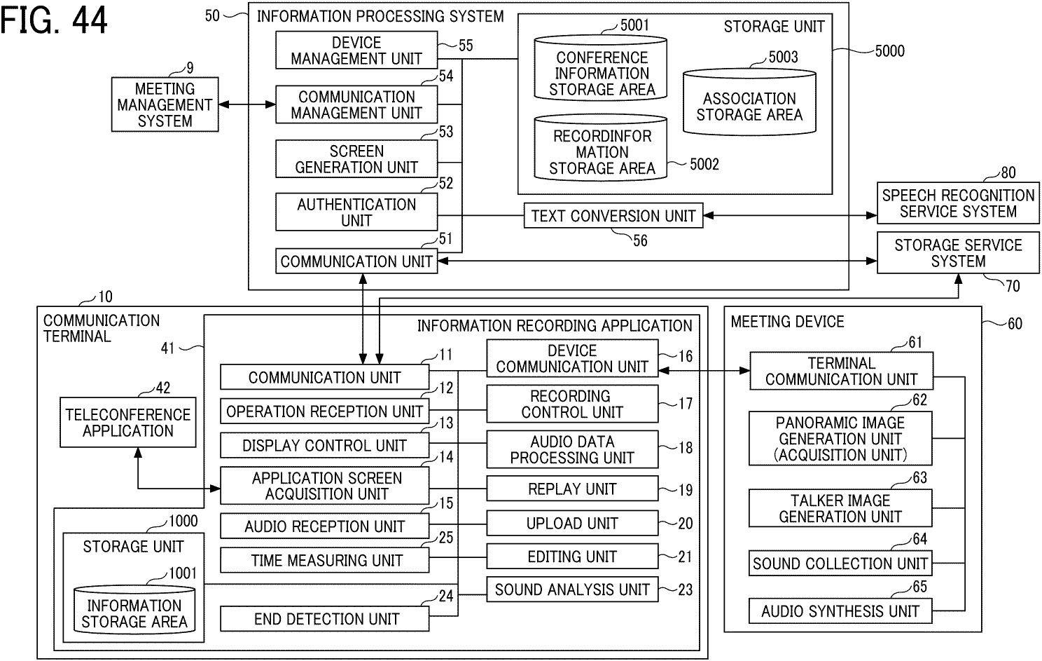

FIG. 44 is an example of a functional block diagram illustrating, as individual blocks, functions of the communication terminal 10, the meeting device 60, and the information processing system 50 of the record creation system 100. In the following description with reference to FIG. 44, the differences from FIG. 33 are mainly described.

In FIG. 44, the communication terminal 10 includes the end detection unit 24. Based on the determination that a pilot signal is not included in the sound received by the microphone of the meeting device 60, for example, in a predetermined period set by a manufacturer or provider of the system, the end detection unit 24 detects that the conference has ended. That is, during the conference (during recording), the electronic whiteboard 2 intermittently outputs the pilot signal, and the conference end (recording end) can be detected when the meeting device 60 no longer receives the pilot signal.

According to such processing, even if the user does not press the stop recording button 227, the user can end the conference with a gesture of blocking the electronic whiteboard 2 from the meeting device 60 with his/her hand or by leaving the conference room with the communication terminal 10 and the meeting device 60 connected to each other.

### Operation or Processing

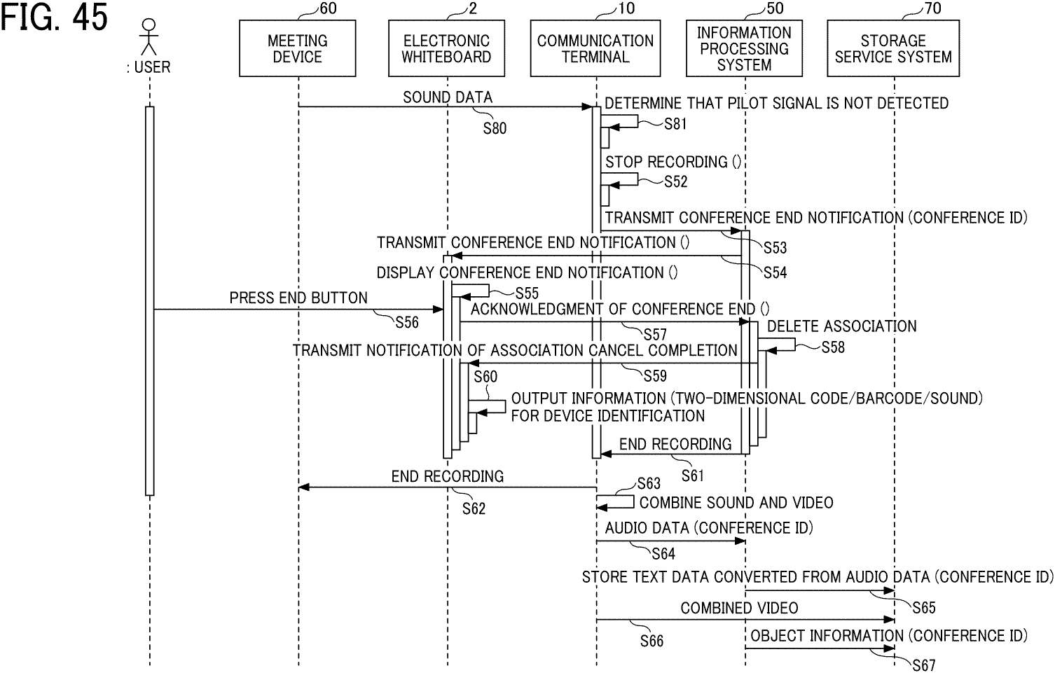

FIG. 45 is a sequence diagram illustrating processing performed by the record creation system 100 when ending the recording of a conference. In the following description with reference to FIG. 45, the differences from FIG. 39 are mainly described.

S80: The terminal communication unit 61 of the meeting device 60 transmits sound data to the communication terminal 10.

S81: The end detection unit 24 determines whether or not a pilot signal is included in the sound data transmitted from the meeting device 60 as described above. The information recording application 41 may directly perform this determination on the sound collected by the information recording application 41, or may receive the result indicating that the pilot signal is not detected, from the meeting device 60.

Subsequent processing may be similar to the processing in FIG. 39.

According to the present embodiment, in addition to the effect of Embodiment 3, it is possible to reduce the number of operation steps of the user for ending the conference (recording).

While the present disclosure has been described above using the embodiment, the embodiment does not limit the present disclosure in any way. Various modifications and replacements may be made within a scope not departing from the gist of the present disclosure. For example, elements and/or features of different illustrative embodiments may be combined with each other and/or substituted for each other within the scope of the present invention. Any one of the above-described operations may be performed in various other ways, for example, in an order different from the one described above.

For example, the communication terminal 10 and the meeting device 60 may be integral with each other. In one example, the meeting device 60 is externally attached to the communication terminal 10. The meeting device 60 may be implemented by a hemispherical camera, a microphone, and a speaker connected to one another by cables.

The meeting device 60 may be disposed at the second site 101. The meeting device 60 at the second site 101 separately creates a combined video and text data. A plurality of meeting devices 60 may be disposed at a single site. In this case, multiple records are created for each meeting device 60.

The arrangement of the panoramic image 203, the talker images 204, and the screen of the application in the combined video in the present embodiment is merely an example. The panoramic image 203 may be displayed below the talker images 204, the user may change the arrangement, or the user may switch between non-display and display individually for the panoramic image 203 and the talker images 204 during playback.

The functional configurations illustrated in, for example, FIG. 9 are divided according to main functions in order to facilitate understanding of processing executed by the communication terminal 10, the meeting device 60, and the information processing system 50. No limitation is intended by how the functions are divided by process or by the name of the functions. The processes performed by the communication terminal 10, the meeting device 60, and the information processing system 50 may be divided into a greater number of processing units in accordance with the content of the processing. In addition, a single processing unit can be further divided into a plurality of processing units.

The apparatuses or devices described in one embodiment are just one example of multiple computing environments that implement the one embodiment in this specification. In some embodiments, the information processing system 50 includes multiple computing devices, such as a server cluster. The plural computing devices communicate with one another through any type of communication link including a network, shared memory, etc., and perform the processes disclosed herein.

The information processing system 50 may share the processing steps disclosed herein, for example, steps in FIG. 20 or the like in various combinations. For example, a process performed by a predetermined unit may be performed by a plurality of information processing apparatuses included in the information processing system 50. Further, the elements of the information processing system 50 may be combined into one server apparatus or are allocated to multiple apparatuses.

Each of the functions of the above-described embodiments may be implemented by one or more pieces of processing circuitry. The term “processing circuit or circuitry” used herein refers to a processor that is programmed to carry out each function by software such as a processor implemented by an electronic circuit, or a device such as an application specific integrated circuit (ASIC), digital signal processor (DSP), field programmable gate array (FPGA), or existing circuit module that is designed to carry out each function described above.

Processors are considered processing circuitry or circuitry as they include transistors and other circuitry therein. In the disclosure, the circuitry, units, or means are hardware that carries out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A device management system comprising:
a first device including first circuitry configured to output a device identifier of the first device;
a second device including second circuitry configured to:
acquire the device identifier output by the first device; and
transmit the device identifier to a communication terminal that communicates with an information processing server; and
the information processing server including third circuitry configured to:
receive the device identifier from the communication terminal: and
in response to receiving the device identifier, enable the first device to be used in a communication with the communication terminal to process information relating to the communication.

2. The device management system according to claim 1,
wherein, in response to receiving the device identifier, the third circuitry is further configured to issue a communication identifier identifying the communication; and
transmit the communication identifier to the first device and the communication terminal.

3. The device management system according to claim 2,
wherein the third circuitry is configured to store, in a memory, the communication identifier and the device identifier of the first device transmitted from the communication terminal in association with each other, so as to enable the first device to be used in the communication.

4. The device management system according to claim 1,
wherein the first device further includes a display, and the first circuitry is configured to transmit object information in association with the communication identifier to the information processing server, the object information being information on an object displayed on the display by the first device, and
wherein the second circuitry is configured to generate surrounding image data representing surroundings around the second device in the communication and transmit the surrounding image data to the communication terminal,
wherein the third circuitry is configured to:
receive, from the communication terminal, the surrounding image data and the communication identifier; and
store, in a memory, the object information and the surrounding image data in association with the communication identifier.

5. The device management system according to claim 1,
wherein the first device further includes a display, and the first circuitry is configured to display, on the display, a device identifier code in which the device identifier is encoded, the device identifier code being one of a two-dimensional code and a barcode,
wherein the second device further includes a camera, and the second circuitry captures, with the camera, an image of the device identifier code, and
wherein the third circuitry is configured to receive, from the communication terminal, the device identifier decoded from the device identifier code.

6. The device management system according to claim 5,
wherein the first circuitry is configured to display the device identifier code above a center line of a screen of the display.

7. The device management system according to claim 5,
wherein the first circuitry is configured to display a center of the device identifier code above a center line of a screen of the display.

8. The device management system according to claim 1,
wherein the first circuitry is configured to output a sound signal in which the device identifier is encoded, and
the second circuitry is configured to collect the sound signal, and
wherein the third circuitry is configured to receive, from the communication terminal, the device identifier decoded from the sound signal.

9. The device management system according to claim 8,
wherein the first circuitry is configured to output the sound signal by frequency of ultrasonic waves.

10. The device management system according to claim 1, further comprising the communication terminal including terminal circuitry configured to:
measure a time starting from activation of an application that communicates with the second device; and
based on a determination that the device identifier is not acquired within a predetermined time starting from the activation of the application, display, on a display, a message indicating that the device identifier is not acquired.

11. The device management system according to claim 4, further comprising the communication terminal including terminal circuitry configured to:
record the surrounding image data received from the second device;
detect an end of recording of the surrounding image data; and
transmit, to the information processing server, a notification of the end of recording; and
wherein the third circuitry of the information processing server is configured to transmit, to the first device, a notification that recording of the object information is to end.

12. The device management system according to claim 11.
wherein the terminal circuitry of the communication terminal is configured to:
display, on a display, a visual representation for receiving an instruction for ending the recording; and
detect the end of recording based on pressing the visual representation.

13. The device management system according to claim 11,
wherein the first device further includes a display, and the first circuitry is configured to display, on the display, a device identifier code in which the device identifier is encoded, the device identifier code being one of a two-dimensional code and a barcode,
wherein the terminal circuitry of the communication terminal is configured to:
detect a shape of the first device based on the device identifier code in the surrounding image data received from the second device: and
detect an end of recording based on a determination of absence of the shape of the first device in the surrounding image data repeatedly transmitted from the second device.

14. The device management system according to claim 11,
wherein the first circuitry is configured to output a sound signal having a predetermined frequency,
wherein the second circuitry is configured to collect sounds output from the first device and convert the collected sound into sound data, and
wherein the terminal circuitry of the communication terminal is configured to detect the end of recording based on a determination that the sound signal having the predetermined frequency is not detected from the sound data received from the second device.

15. The device management system according to claim 11,
wherein the communication terminal and the second device are connected by a cable, and
wherein the terminal circuitry of the communication terminal is configured to detect the end of recording in response to detecting pulling out of the cable from the communication terminal.

16. The device management system according to claim 11,
wherein, in response to receiving the notification that recording of the object information is to end, the first circuitry is configured to display, on the display, a display component for receiving an instruction on whether to end the recording of the object information, and
wherein, in response to receiving an instruction of ending the recording input to the display component, the first circuitry is configured to end transmission of the object information to the information processing server.

17. An information processing system comprising circuitry configured to:
receive, from a communication terminal, a device identifier identifying a first device and being output by the first device and acquired by a second device that communicates with the communication terminal; and
in response to receiving the device identifier, enable the first device to be used in a communication for processing information relating to the communication.

18. A device management method performed by an information processing system that communicates with a communication terminal, the method comprising:
receiving, from the communication terminal, a device identifier identifying a first device, the device identifier being received by the communication terminal from a second device that acquires the device identifier output by the first device; and
in response to receiving the device identifier, enabling the first device to be used in a communication with the communication terminal to process information relating to the communication.

19. A non-transitory recording medium storing a plurality of program codes which, when executed by one or more processors, causes the processors to perform a method, the method comprising:
receiving, from the communication terminal, a device identifier identifying a first device, the device identifier being received by the communication terminal from a second device that acquires the device identifier output by the first device: and
in response to receiving the device identifier, enabling the first device to be used in a communication with the communication terminal to process information relating to the communication.

20. An information processing device comprising circuitry configured to:
acquire a device identifier output from another information processing device to be used in a communication, the device identifier identifying the another information processing device: and
in response to receiving the device identifier, transmit the device identifier to an information processing system that enables the another information processing device to be used in the communication.

21. An information processing device comprising circuitry configured to:
acquire a device identifier output from another information processing device to be used in a communication with a communication terminal to process information relating to the communication, the device identifier identifying the another information processing device; and
transmit the device identifier to the communication terminal,
wherein the communication terminal transmits the device identifier to an information processing system, and the information processing system enables the another information processing device to be used in the communication in response to receiving the device identifier.
